(19) United States
(12) Patent Application Publication
(10) Pub. No.: US 2025/0365452 A1
(43) Pub. Date: Nov. 27, 2025

(54) Systems and methods for unifying and managing multi content delivery networks

(71) Applicant: IORIVER LTD., Yahud (IL)

(72) Inventors: Michael Hakimi, Holon (IL); Alex Khazanovitch, Nesher (IL); Edward Tsinovoi, Yahud (IL)

(21) Appl. No.: 19/212,738

(22) Filed: May 20, 2025

Related U.S. Application Data
(60) Provisional application No. 63/651,084, filed on May 23, 2024.

(51) Int. Cl. H04N 21/21; H04L 47/125; H04N 21/262

(52) U.S. Cl. CPC H04N 21/21; H04L 47/125; H04N 21/26291

(57) ABSTRACT

Systems and methods for managing, unifying, or upgrading Multi-Content-Delivery-Networks (Multi-CDNs) are disclosed. A system for enabling a Multi-CDN to provide one or more unified services, where the Multi-CDN includes multiple different CDNs provided by multiple different CDN providers, where one CDN of the multiple CDNs employs edge computing technology enabling a user of the Multi-CDN to execute custom code on platforms of the at least one respective CDN, includes at least one hardware processor and at least one computer readable storage device storing instructions for execution by the at least one hardware processor. The instructions, when executed, cause the system to enable the Multi-CDN to provide one or more unified services across the multiple different CDNs by utilizing the edge computing technology employed by the at least one CDN, where each unified service of the one or more unified services provides a consistent service across the multiple different CDNs.

### CROSS-REFERENCE TO RELATED APPLICATION

This application claims the benefit of U.S. Provisional Patent Application 63/651,084, filed May 23, 2024, which is incorporated herein by reference.

### FIELD

The present disclosure relates generally to Multi-Content-Delivery-Networks (Multi-CDNs), and more specifically, to systems and methods for managing, unifying, or upgrading Multi-CDNs.

### BACKGROUND

A CDN (Content Delivery Network) is a network of geographically distributed servers (e.g., edge servers) that brings web content closer to where end users are located, to ensure high availability, optimized performance, and low latency. A Multi-CDN is the practice of employing a number of CDN providers simultaneously. This method augments the performance benefits of using a CDN while also ensuring redundancy and resilience and reducing costs. To implement a Multi-CDN, organizations can use traffic management tools or Multi-CDN switching solutions that distribute and route content across the various CDN providers.

### SUMMARY

The present disclosure relates to systems and methods for managing, unifying, or upgrading Multi-CDNs. The disclosed systems and methods may be conducted in a variety of manners and configurations.

In accordance with aspects of the present disclosure, a system for enabling a Multi-CDN to provide one or more unified services is disclosed. The Multi-CDN comprises multiple different Content Delivery Networks (CDNs) provided by multiple different CDN providers, where at least one CDN of the multiple different CDNs of the Multi-CDN employs edge computing technology which enables a user of the Multi-CDN to execute custom code on platforms of the at least one respective CDN. The system includes at least one hardware processor and at least one computer readable storage device. The storage device stores instructions for execution by the at least one hardware processor. The instructions, when executed, cause the system to enable the Multi-CDN to provide one or more unified services across the multiple different CDNs by utilizing the edge computing technology employed by the at least one CDN, where each unified service of the one or more unified services provides a consistent service across the multiple different CDNs.

In various embodiments of the system, the at least one CDN of the multiple different CDNs employing edge computing technology includes the multiple different CDNs of the Multi-CDN, where the one or more unified services includes one or more unified application services.

In various embodiments of the system, the instructions, when executed, further cause the system to provide the one or more unified application services via the edge computing technology.

In various embodiments of the system, the one or more unified services include one or more unified CDN services.

In various embodiments of the system, the instructions, when executed, further cause the system to unify one or more CDN services via the edge computing technology, to enable the one or more unified CDN services, respectively, and where each CDN service of the one or more CDN services is provided by at least one CDN of the Multi-CDN.

In various embodiments of the system, different CDNs of the multiple different CDNs have at least one of: different architecture, different API, different implementation of one or more application services, or different programming language support.

In various embodiments of the system, each CDN of the multiple different CDNs is provided by a different CDN provider of the multiple different CDN providers.

In various embodiments of the system, the system further includes a unified management system, where the unified management system allows the management of the multiple different CDNs in a unified and consistent manner.

In various embodiments of the system, the unified management system is configured to communicate with a supervisor component, and the supervisor component is configured to communicate with the multiple different CDNs.

In various embodiments of the system, the unified management system allows management of the multiple different CDNs as a single CDN.

In various embodiments of the system, the unified management system includes a User Interface (UI), where management of the multiple different CDNs is performed by receiving user instruction via the UI.

In various embodiments of the system, the unified management system includes a single API.

In various embodiments of the system, the unified management system allows management of services executed on the multiple different CDNs, where the services are selected from: CDN services, unified services, or a combination thereof.

In various embodiments of the system, the instructions, when executed, further cause the system to select the multiple different CDN providers.

In various embodiments of the system, the selection of the multiple different CDN providers is based on at least one of: performance, availability or cost, or a combination thereof.

In various embodiments of the system, the user is a content provider and the multiple different CDNs are used for delivering content of the content provider.

In various embodiments of the system, the Multi-CDN may provide a user with a maximal level of service capabilities, where the maximal level is the highest common level of service capabilities provided by the multiple different CDNs; and enabling the Multi-CDN to provide one or more unified services includes upgrading the maximal level of service capabilities of the Multi-CDN.

In various embodiments of the system, the upgrading of the maximal level of service capabilities of the Multi-CDN includes causing the provision of one or more services, which the Multi-CDN was not capable of providing prior to the upgrading, where the one or more services are unified services.

In various embodiments of the system, the one or more unified services include one or more unified application services, where the at least one CDN of the plurality of CDNs employing edge computing technology includes the multiple different CDNs of the Multi-CDN.

In various embodiments of the system, the types of services provided by the one or more unified application services are selected from: security, edge-computing, traffic control or content processing.

In various embodiments of the system, the unified security application services include at least one application service selected from: Web Application Firewall (WAF), bot detection, rate-limiting, Distributed Denial-of-Service (DDoS) protection, API security, client reputation, or anomaly detection.

In various embodiments of the system, the unified traffic control application services include at least one application service selected from: origin load balancing or origin routing.

In various embodiments of the system, the unified content processing application services includes at least one application service selected from: image and video optimization or image and video manipulation.

In various embodiments of the system, the implementation of the one or more unified application services is performed via an edge compute layer deployed on top of the multiple different CDNs platforms based on the edge computing technology employed by the multiple different CDNs.

In various embodiments of the system, the edge compute layer is deployed via one or more worker agents, where each worker agent of the one or more worker agents is installed on a platform of a CDN of the multiple different CDNs via the edge computing technology, respectively, and where the one or more unified application services are executed on the multiple CDNs platforms via the one or more worker agents.

In various embodiments of the system, the one or more worker agents are further configured to report to a supervisor component, and to receive instructions from the supervisor component to be applied to the multiple different CDNs, respectively.

In various embodiments of the system, the instructions, when executed, further cause the system, when an update to the one or more worker agents is required, to gradually deploy one or more updated worker agents while monitoring error reports following the deployment.

In various embodiments of the system, a unified application service of the one or more unified application services utilizes corresponding one or more application services offered by one or more CDN providers of the multiple different CDN providers, respectively.

In various embodiments of the system, the one or more unified application services include a unified edge-computing application service.

In various embodiments of the system, the unified edge-computing application service provides a unified programming language and includes at least one of: one or more Application Programming Interfaces (APIs), a runtime environment, a shared persistent state, or a combination thereof.

In various embodiments of the system, the instructions, when executed, further cause the system to receive a piece of code written in the unified programming language entered by the user and apply the piece of code to CDNs of the multiple different CDNs via the unified edge-computing application service.

In various embodiments of the system, each unified application service includes one or more pieces of code, where each piece of code of the one or more pieces of code is executed by one or more CDNs of the multiple different CDNs.

In various embodiments of the system, the one or more services include one or more CDN services.

In various embodiments of the system, for each CDN service of the one or more CDN services: a portion of the multiple different CDNs is not capable of providing the CDN service, the rest of the multiple different CDNs are capable of providing the CDN service, the at least plurality of CDNs employing edge computing technology include the portion of the CDNs not capable of providing the CDN service, and the upgrading of the level of capabilities of the Multi-CDN includes causing the portion of CDNs to provide the CDN service by utilizing the edge computing technology employed by the portion of CDNs, respectively.

In various embodiments of the system, each CDN of the multiple different CDNs of the Multi-CDN is capable of providing a CDN service at a certain level of service capability, at least some of the CDNs of the multiple different CDNs are capable of providing the CDN service at different levels of service capability, the Multi-CDN may provide the user with the CDN service at the lowest level of service capability of the different levels of service capability, and upgrading of the level of capabilities of the Multi-CDN includes causing the Multi-CDN to provide the CDN service at an upgraded level of service capability higher than the lowest level of service capability and selected from the different levels, by causing the one or more CDNs which may provide the CDN service at a level of service capability lower than the upgraded level of service capability to provide the CDN service at the upgraded level of service capability, and where the one or more CDNs, capable of providing the CDN service at a level lower than the upgraded level of service capability, employ edge computing technology.

In accordance with aspects of the present disclosure, a computerized method for enabling a Multi-CDN to provide one or more unified services is disclosed. The Multi-CDN includes multiple different CDNs provided by multiple different CDN providers, where at least one CDN of the multiple different CDNs of the Multi-CDN employs edge computing technology which enables the user of the Multi-CDN to execute custom code on platforms of the respective CDNs. The method includes enabling the Multi-CDN to provide one or more unified services across the multiple different CDNs by utilizing the edge computing technology employed by the at least one CDN, where each unified service of the one or more unified services provides a consistent service across the multiple different CDNs.

In various embodiments of the method, the at least one CDN of the multiple different CDNs employing edge computing technology includes the multiple different CDNs of the Multi-CDN, where the one or more unified services include one or more unified application services.

In various embodiments of the method, the method further includes providing the one or more unified application services via the edge computing technology.

In various embodiments of the method, the one or more unified services include one or more unified CDN services.

In various embodiments of the method, the method further includes unifying one or more CDN services via the edge computing technology, to enable the one or more unified CDN services, respectively, where each CDN service of the one or more CDN services is provided by at least one CDN of the Multi-CDN.

In various embodiments of the method, different CDNs of the multiple different CDNs have at least one of: different architecture, different API, different implementation of one or more application services, or different programming language support.

In various embodiments of the method, each CDN of the multiple different CDNs is provided by a different CDN provider of the multiple different CDN providers.

In various embodiments of the method, the method further includes allowing the management of the multiple different CDNs in a unified and consistent manner via a unified management system.

In various embodiments of the method, the method further includes communicating with a supervisor component, where the supervisor component is configured to communicate with the multiple different CDNs.

In various embodiments of the method, allowing management of the multiple different CDNs includes allowing the management of the multiple different CDNs as a single CDN.

In various embodiments of the method, management of the multiple different CDNs is performed by receiving user instruction via a UI.

In various embodiments of the method, the unified management system includes a single API.

In various embodiments of the method, the method further includes allowing management of services executed on the multiple different CDNs, where the services are selected from: CDN services, unified application services or a combination thereof.

In various embodiments of the method, the method further includes selecting the multiple different CDN providers.

In various embodiments of the method, the selection of the multiple different CDN providers is based on at least one of: performance, availability or cost, or a combination thereof.

In various embodiments of the method, the user is a content provider and the multiple different CDNs are used for delivering content of the content provider.

In various embodiments of the method, the Multi-CDN may provide a user with a maximal level of service capabilities, where the maximal level is the highest common level of service capabilities provided by the multiple different CDNs, and where enabling the Multi-CDN to provide one or more unified services includes upgrading the maximal level of service capabilities of the Multi-CDN.

In various embodiments of the method, the upgrading of the maximal level of service capabilities of the Multi-CDN includes causing the provision of one or more services, which the Multi-CDN was not capable of providing prior to the upgrading, and where the one or more services are unified services.

In various embodiments of the method, the one or more services include one or more unified application services, where the at least plurality of CDNs employing edge computing technology includes the multiple different CDNs of the Multi-CDN.

In various embodiments of the method, the types of services provided by the one or more unified application services are selected from: security, edge-computing, traffic control or content processing.

In various embodiments of the method, the unified security application services include at least one application service selected from: Web Application Firewall (WAF), bot detection, rate-limiting, Distributed Denial-of-Service (DDoS) protection, API security, client reputation, or anomaly detection.

In various embodiments of the method, the unified traffic control application services include at least one application service selected from: origin load balancing or origin routing.

In various embodiments of the method, the unified content processing application services include at least one application service selected from: image and video optimization or image and video manipulation.

In various embodiments of the method, the method further includes deploying an edge compute layer on top of the multiple different CDNs platforms based on the edge computing technology employed by the multiple different CDNs, where causing the provision of the one or more unified application services is performed via the deployed edge compute layer.

In various embodiments of the method, the deploying of the edge compute layer includes installing one or more worker agents on platforms of the multiple different CDNs via the edge computing technology, where the one or more unified application services are executed on the multiple CDNs platforms via the one or more worker agents.

In various embodiments of the method, the one or more worker agents are further configured to report to a supervisor component, and to receive instructions from the supervisor component to be applied to the multiple different CDNs, respectively.

In various embodiments of the method, the method further includes, when an update to the one or more worker agents is required, gradually deploying one or more updated worker agents while monitoring error reports following the deployment.

In various embodiments of the method, the one or more unified application services include a unified edge-computing application service.

In various embodiments of the method, the unified edge-computing application service provides a unified programming language and includes at least one of: one or more Application Programming Interfaces (APIs), a runtime environment, a shared persistent state, or a combination thereof.

In various embodiments of the method, the method further includes receiving a piece of code written in the unified programming language entered by the user and applying the piece of code to CDNs of the multiple different CDNs via the unified edge-computing application service.

In various embodiments of the method, each unified application service includes one or more pieces of code, where each piece of code of the one or more pieces of code is executed by one or more CDNs of the multiple different CDNs.

In various embodiments of the method, the one or more services include one or more CDN services.

In various embodiments of the method, for each CDN service of the one or more CDN services, a portion of the multiple different CDNs is not capable of providing the CDN service; the rest of the multiple different CDNs are capable of providing the CDN service; the at least plurality of CDNs employing edge computing technology include the portion of the CDNs not capable of providing the CDN service; and the upgrading of the level of capabilities of the Multi-CDN includes causing the portion of CDNs to provide the CDN service by utilizing the edge computing technology employed by the portion of CDNs, respectively.

In various embodiments of the method, each CDN of the multiple different CDNs of the Multi-CDN is capable of providing a CDN service at a certain level of service capability; at least some of the CDNs of the multiple different CDNs are capable of providing the CDN service at different levels of service capability; the Multi-CDN may provide the user with the CDN service at the lowest level of service capability of the different levels of service capability; upgrading of the level of capabilities of the Multi-CDN includes causing the Multi-CDN to provide the CDN service at an upgraded level of service capability higher than the lowest level of service capability and selected from the different levels, by causing the one or more CDNs, which may provide the CDN service at a level of service capability lower than the upgraded level of service capability, to provide the CDN service at the upgraded level of service capability; and the one or more CDNs, capable of providing the CDN service at a level lower than the upgraded level of service capability, employ edge computing technology.

In accordance with aspects of the present disclosure, a system for providing unified application services on top of multiple different CDNs provided by multiple different CDN providers is disclosed. Each CDN of the multiple different CDNs employs edge computing technology which enables a user of the multiple different CDNs to execute custom code on the platform of the respective CDN. The system includes at least one hardware processor and at least one computer readable storage device storing instructions for execution by the at least one hardware processor, the instructions, when executed, cause the system to implement one or more unified application services to be executed on the platforms of the multiple different CDNs by employing the edge computing technology, where each service provided by each unified application service of the one or more unified application services is consistent across the multiple different CDNs.

In accordance with aspects of the present disclosure, a computerized method for providing unified application services on top of multiple different CDNs provided by multiple different CDN providers is disclosed. Each CDN of the multiple different CDNs employs edge computing technology which enables a user of the multiple different CDNs to execute custom code on the platform of the respective CDN. The method includes implementing one or more unified application services to be executed on the platforms of the multiple different CDNs by employing the edge computing technology, where each service provided by each unified application service of the one or more unified application services is consistent across the multiple different CDNs.

In accordance with aspects of the present disclosure, a system for providing a unified management of a Multi-CDN is disclosed. The Multi-CDN includes multiple different CDNs provided by multiple different CDN providers. The system includes at least one hardware processor and at least one computer readable storage device storing instructions for execution by the at least one hardware processor. The instructions, when executed, cause the system to receive the user instructions via a UI with respect to the Multi-CDN as a single CDN, and apply the user instructions to the multiple different CDNs of the Multi-CDN.

In various embodiments of the system, the instructions, when executed, further cause the system to allow the user to configure each CDN of the multiple different CDNs of the Multi-CDN via the UI, where the configuration of each CDN includes configuring services provided by the CDN.

In various embodiments of the system, different CDNs of the multiple different CDNs have at least one of: different architectures, different APIs, different implementation of one or more application services, or different programming languages support.

In various embodiments of the system, each CDN of the multiple different CDNs is provided by a different CDN provider of the multiple different CDN providers.

In various embodiments of the system, the instructions, when executed, further cause the system to implement a supervisor component configured to communicate with each CDN of the multiple different CDNs, where the UI is configured to communicate with the supervisor component.

In various embodiments of the system, the supervisor component is configured to communicate with each CDN of the multiple different CDNs via a respective API.

In various embodiments of the system, at least one CDN of the multiple different CDNs of the Multi-CDN employs edge computing technology which enables a user of the Multi-CDN to execute custom code on a platform of the respective CDN, where one or more instructions of the user instructions are applied to one or more CDNs of the at least one CDN while utilizing the edge computing technology employed by the one or more CDNs, respectively.

In various embodiments of the system, the provided unified management of the Multi-CDN includes management of one or more unified services by utilizing the edge computing technology employed by the at least one CDN, where each unified service of the one or more unified services provides a consistent service across the multiple different CDNs.

In various embodiments of the system, the one or more unified services include one or more unified application services, where the at least plurality of CDNs employing edge computing technology includes the multiple different CDNs of the Multi-CDN.

In various embodiments of the system, the types of services provided by the one or more unified application services are selected from: security, edge-computing, traffic control or content processing.

In various embodiments of the system, the one or more unified application services include a unified edge-computing application service.

In various embodiments of the system, the unified edge-computing application service provides a unified programming language and includes at least one of: one or more APIs, a runtime environment, a shared persistent state or a combination thereof.

In various embodiments of the system, the instructions, when executed, further cause the system to receive a user selection, via the UI, of the provided one or more unified application services.

In various embodiments of the system, the Multi-CDN may provide a user with a maximal level of service capabilities, where the maximal level is the highest common level of service capabilities provided by the multiple different CDNs. The instructions, when executed, may then further cause the unified management system to upgrade the maximal level of service capabilities of the Multi-CDN by causing the Multi-CDN to provide the one or more unified services.

In various embodiments of the system, the upgrading of the maximal level of service capabilities of the Multi-CDN includes causing the Multi-CDN to provide one or more services, which the Multi-CDN was not capable of providing prior to the upgrading, where the one or more services are unified services.

In various embodiments of the system, the one or more services include one or more CDN services.

In various embodiments of the system, for each CDN service of the one or more CDN services, a portion of the multiple different CDNs is not capable of providing the CDN service, the rest of the multiple different CDNs are capable of providing the CDN service, the at least plurality of CDNs employing edge computing technology include the portion of the CDNs not capable of providing the CDN service, and the upgrading of the level of capabilities of the Multi-CDN includes causing the portion of CDNs to provide the CDN service by utilizing the edge computing technology employed by the portion of CDNs, respectively.

In various embodiments of the system, each CDN of the multiple different CDNs of the Multi-CDN is capable of providing a CDN service at a certain level of service capability, at least some of the CDNs of the multiple different CDNs are capable of providing the CDN service at different levels of service capability, and the Multi-CDN may provide the user with the CDN service at the lowest level of service capability of the different levels of service capability. Upgrading of the level of capabilities of the Multi-CDN may then include causing the Multi-CDN to provide the CDN service at an upgraded level of service capability higher than the lowest level of service capability and selected from the different levels, by causing the one or more CDNs, which may provide the CDN service at a level of service capability lower than the upgraded level of service capability, to provide the CDN service at the upgraded level of service capability, where the one or more CDNs, capable of providing the CDN service at a level lower than the upgraded level of service capability, employ edge computing technology.

In various embodiments of the system, the instructions, when executed, further cause the system to deploy one or more worker agents. Each worker agent of the one or more worker agents may be installed on a platform of a CDN of the multiple different CDNs via the edge computing technology, respectively. The application of user instructions of the one or more user instructions while utilizing the edge computing technology may then be performed via the one or more worker agents.

In various embodiments of the system, the instructions, when executed, may further cause the system to deploy an edge compute layer on top of platforms of the multiple different CDNs via the one or more worker agents.

In various embodiments of the system, the instructions, when executed, further cause the system to implement a supervisor component and the one or more worker agents are further configured to report to the supervisor component, and to receive instructions from the supervisor component to be applied to the multiple different CDNs, respectively.

In various embodiments of the system, the system provides a single API.

In various embodiments of the system, the instructions, when executed, further cause the system to select the multiple different CDN providers.

In various embodiments of the system, the UI includes at least one of: a Graphical User Interface (GUI), an API, an Infrastructure As a Code (IAC) component, a Command Line Interface (CLI), a REST API, a programmatic interface, or a combination thereof.

In various embodiments of the system, the instructions, when executed, further cause the system to set up a GUI, where the UI includes the GUI.

In accordance with aspects of the present disclosure, a computerized method for providing a unified management of a Multi-CDN is disclosed. The Multi-CDN includes multiple different CDNs provided by multiple different CDN providers. The method includes receiving the user instructions via a UI with respect to the Multi-CDN as a single CDN and applying the user instructions to the multiple different CDNs of the Multi-CDN.

In various embodiments of the method, the instructions, further include allowing the user to configure each CDN of the multiple different CDNs of the Multi-CDN via the UI, where the configuration of each CDN includes configuring services provided by the CDN.

In various embodiments of the method, different CDNs of the multiple different CDNs have at least one of: different architectures, different APIs, different implementation of one or more application services, or different programming languages support.

In various embodiments of the method, each CDN of the multiple different CDNs is provided by a different CDN provider of the multiple different CDN providers.

In various embodiments of the method, the method further includes implementing a supervisor component configured to communicate with each CDN of the multiple different CDNs, where the UI is configured to communicate with the supervisor component.

In various embodiments of the method, the supervisor component is configured to communicate with each CDN of the multiple different CDNs via a respective API.

In various embodiments of the method, at least one CDN of the multiple different CDNs of the Multi-CDN employs edge computing technology which enables a user of the Multi-CDN to execute custom code on a platform of the respective CDN, where one or more instructions of the user instructions are applied to one or more CDNs of the at least one CDN while utilizing the edge computing technology employed by the one or more CDNs, respectively.

In various embodiments of the method, the provided unified management of the Multi-CDN includes management of one or more unified services by utilizing the edge computing technology employed by the at least one CDN, where each unified service of the one or more unified services provides a consistent service across the multiple different CDNs.

In various embodiments of the method, the one or more unified services include one or more unified application services, where the at least plurality of CDNs employing edge computing technology includes the multiple different CDNs of the Multi-CDN.

In various embodiments of the method, the types of services provided by the one or more unified application services are selected from: security, edge-computing, traffic control or content processing.

In various embodiments of the method, the one or more unified application services include a unified edge-computing application service.

In various embodiments of the method, the unified edge-computing application service provides a unified programming language and includes one or more APIs and a runtime environment.

In various embodiments of the method, the method further includes receiving a user selection, via the UI, of the provided one or more unified application services.

In various embodiments of the method, the Multi-CDN may provide a user with a maximal level of service capabilities, where the maximal level is the highest common level of service capabilities provided by the multiple different CDNs, and where the method further includes upgrading the maximal level of service capabilities of the Multi-CDN by causing the Multi-CDN to provide the one or more unified services.

In various embodiments of the method, the upgrading of the maximal level of service capabilities of the Multi-CDN includes causing the Multi-CDN to provide one or more services, which the Multi-CDN was not capable of providing prior to the upgrading, where the one or more services are unified services.

In various embodiments of the method, the one or more services include one or more CDN services.

In various embodiments of the method, for each CDN service of the one or more CDN services a portion of the multiple different CDNs is not capable of providing the CDN service, the rest of the multiple different CDNs are capable of providing the CDN service, and the at least plurality of CDNs employing edge computing technology include the portion of the CDNs not capable of providing the CDN service, where the upgrading of the level of capabilities of the Multi-CDN includes causing the portion of CDNs to provide the CDN service by utilizing the edge computing technology employed by the portion of CDNs, respectively.

In various embodiments of the method, each CDN of the multiple different CDNs of the Multi-CDN is capable of providing a CDN service at a certain level of service capability, at least some of the CDNs of the multiple different CDNs are capable of providing the CDN service at different levels of service capability, and the Multi-CDN may provide the user with the CDN service at the lowest level of service capability of the different levels of service capability, where upgrading of the level of capabilities of the Multi-CDN includes causing the Multi-CDN to provide the CDN service at an upgraded level of service capability higher than the lowest level of service capability and selected from the different levels, by causing the one or more CDNs which may provide the CDN service at a level of service capability lower than the upgraded level of service capability to provide the CDN service at the upgraded level of service capability, and where the one or more CDNs, capable of providing the CDN service at a level lower than the upgraded level of service capability, employ edge computing technology.

In various embodiments of the method, the method further includes deploying one or more worker agents, each worker agent of the one or more worker agents is installed on a platform of a CDN of the multiple different CDNs via the edge computing technology, respectively, where application of user instructions of the one or more user instructions while utilizing the edge computing technology is performed via the one or more worker agents.

In various embodiments of the method, the method further includes deploying an edge compute layer on top of platforms of the multiple different CDNs via the one or more worker agents.

In various embodiments of the method, the method further includes implementing a supervisor component where the one or more worker agents are further configured to report to the supervisor component, and to receive instructions from the supervisor component to be applied to the multiple different CDNs, respectively.

In various embodiments of the method, the method further includes selecting the multiple different CDN providers.

In various embodiments of the method, the UI includes a GUI, an API, an IAC component, a CLI, a REST API, or a programmatic interface or a combination thereof.

In various embodiments of the method, further comprising setting up a GUI, and wherein the UI comprises the GUI.

In accordance with aspects of the present disclosure, a computerized method for providing unified application services on top of multiple different CDNs provided by multiple different CDN providers is disclosed. Each CDN of the multiple different CDNs employs edge computing technology which enables a user of Multiple different CDNs to execute custom code on the platform of the each CDN. The method includes identifying the multiple CDNs, identifying one or more desired unified application services, setting up a plurality of worker agents and deploying the plurality of worker agents on top of platforms of the multiple CDNs via the edge computing technology employed by the multiple CDNs, respectively, setting up a supervisor component configured to be in communication with the plurality of worker agents to receive reports from the worker agents and provide instructions to the worker agents with respect to traffic passing through the multiple different CDNs, respectively; and implementing the desired one or more unified application services on top of platforms of the multiple CDNs via the deployed plurality of worker agents.

In accordance with aspects of the present disclosure, a system for providing a unified management for each Multi-CDN of a plurality of Multi-CDNs, where each Multi-CDN of the plurality of Multi-CDSNs includes multiple different CDNs provided by multiple different CDN providers, the system including at least one hardware processor, at least one computer readable storage device storing instructions for execution by the at least one hardware processor, where the instructions, when executed, cause the system, for each Multi-CDN, to allow configuration of each CDN of the multiple different CDNs of the Multi-CDN via a User Interface (UI), receive instructions via the UI with respect to the multiple different CDNs of the Multi-CDN as a single CDN, and apply the instructions to the multiple different CDNs of the Multi-CDN.

In various embodiments of the system, the instructions, when executed, further cause the system to set up a supervisor component for each Multi-CDN configured to be in communication with the UI and with the respective Multi-CDN, set up a general supervisor component configured to be in communication with each supervisor component of each Multi-CDN of the Multi-CDNs, and utilize data received from one or more supervisor components of respective one or more Multi-CDNs of the Multi-CDNs to provide data or instructions to at least one supervisor component other than the one or more supervisor components.

In accordance with aspects of the present disclosure, a method for providing a unified management for each Multi-CDN of a plurality of Multi-CDNs is disclosed. Each Multi-CDN of the plurality of Multi-CDNs includes multiple different CDNs provided by multiple different CDN providers. The method includes, for each Multi-CDN, allowing configuration of each CDN of the multiple different CDNs of the Multi-CDN via a UI, receiving instructions via the UI with respect to the multiple different CDNs of the Multi-CDN as a single CDN, and applying the instructions to the multiple different CDNs of the Multi-CDN.

In various embodiments of the method, the method further includes setting up a supervisor component for each Multi-CDN configured to be in communication with the UI and with the respective Multi-CDN, setting up a general supervisor component configured to be in communication with each supervisor component of each Multi-CDN of the Multi-CDNs, and utilizing data received from one or more supervisor components of respective one or more Multi-CDNs of the Multi-CDNs to provide data or instructions to at least one supervisor component other than the one or more supervisor components.

In accordance with aspects of the present disclosure, a computer program product for enabling a Multi-CDN to provide one or more unified services is disclosed. The Multi-CDN includes multiple different CDNs provided by multiple different CDN providers, wherein at least one CDN of the multiple different CDNs of the Multi-CDN employs edge computing technology which enables a user of the Multi-CDN to execute custom code on platforms of the at least one respective CDN. The computer product incudes a computer-readable storage medium having computer-executable instructions for enabling the Multi-CDN to provide one or more unified services across the multiple different CDNs by utilizing the edge computing technology employed by the at least one CDN, where each unified service of the one or more unified services provides a consistent service across the multiple different CDNs.

### BRIEF DESCRIPTION OF THE DRAWINGS

The above and other aspects and features of the disclosure will become more apparent in view of the following detailed description when taken in conjunction with the accompanying drawings wherein like reference numerals identify similar or identical elements.

FIG. 1 is a diagram of an exemplary Multi-CDN layout according to prior art;

FIG. 2A is an illustration of exemplary services which may be available by different CDNs of a Multi-CDN architecture according to prior art;

FIG. 2B is an illustration of exemplary unified services which may be provided to a Multi CDN architecture, in accordance with aspects of the present disclosure;

FIG. 3 is a diagram of an exemplary system for management and/or upgrading of an exemplary Multi-CDN in accordance with aspects of the present disclosure;

FIG. 4 is a diagram exemplifying different manners for enabling a Multi-CDN to provide one or more unified services, in accordance with aspects of the present disclosure;

FIG. 5 is a flow diagram of a method for providing unified application services on top of multiple different CDNs (e.g., a Multi-CDN), in accordance with aspects of the present disclosure;

FIG. 6 is a flow diagram of a method for providing a unified management of a Multi-CDN, in accordance with aspects of the present disclosure;

FIG. 7 is a flow diagram of a method for providing unified application services on top of one or more Multi-CDNs, in accordance with other aspects of the present disclosure;

FIG. 8A shows a screen shot of a page of an exemplary Graphical User Interface (GUI) for selecting or adding CDN providers for one or more Multi-CDNs by a user, in accordance with aspects of the present disclosure;

FIG. 8B shows another screen shot of a page of the GUI of FIG. 8A for adding Multi-CDNs, in accordance with aspects of the present disclosure;

FIG. 8C shows another screen shot of a page of the GUI of FIG. 8A for editing traffic policies of a Multi-CDN, in accordance with aspects of the present disclosure;

FIG. 8D shows another screen shot of a page of the GUI of FIG. 8A for configuring a security unified application service of a Web Application Firewall, in accordance with aspects of the present disclosure;

FIG. 8E shows another screen shot of a page of the GUI of FIG. 8A for configuring a security unified application service of rate limiting, in accordance with aspects of the present disclosure; and

FIG. 8F shows yet a further screen shot of a page of the GUI of FIG. 8A for creating custom code to be executed on the Multi-CDN via an edge compute unified application service, in accordance with aspects of the present disclosure;

It will be appreciated that for simplicity and clarity of illustration, elements shown in the figures have not necessarily been drawn to scale. For example, the dimensions and/or aspect ratio of some of the elements can be exaggerated relative to other elements for clarity. Further, where considered appropriate, reference numerals can be repeated among the figures to indicate corresponding or analogous elements throughout the serial views.

### DETAILED DESCRIPTION

The present disclosure relates to systems and methods for managing, unifying, upgrading or any combination thereof, of Multi-CDNs. The disclosed systems and methods unify the services or upgrade the level of service capabilities of a Multi-CDN by utilizing the edge computing technology employed by CDNs of the Multi-CDN. The disclosed systems and methods provide unified application services by providing services which are, e.g., uniform, or consistent across the multiple CDNs of the Multi-CDN. The unified application services are provided by employing edge computing technology provided by the multiple CDNs. Moreover, the disclosed systems and methods provide a holistic solution which allows a user or customer, such as a content provider, to utilize multiple CDNs in a transparent and simple manner. Furthermore, the disclosed systems and methods allow orchestration of a Multi-CDN as a single CDN.

In the following detailed description, specific details are set forth in order to provide a thorough understanding of the disclosure. However, it will be understood by those skilled in the art that the disclosure may be practiced without these specific details. In other instances, well-known methods, procedures, and components have not been described in detail so as not to obscure the present disclosure. Some features or elements described with respect to one system may be combined with features or elements described with respect to other systems. For the sake of clarity, discussion of same or similar features or elements may not be repeated.

Although the disclosure is not limited in this regard, discussions utilizing terms such as, for example, “processing,” “computing,” “calculating,” “determining,” “establishing,” “analyzing,” “checking,” or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although the disclosure is not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like.

Unless explicitly stated, the methods described herein are not constrained to a particular order or sequence. Additionally, some of the described methods or elements thereof can occur or be performed simultaneously, at the same point in time, or concurrently.

Although the disclosure is not limited in this regard, the term “Service” as used herein, may relate to, or include any service provided by a CDN or by the disclosed systems and methods, including, but not limited to, a unified application service, a unified CDN service, or a CDN service.

Although the disclosure is not limited in this regard, the term “Application Service” as used herein, may relate to, or include a service which is not a content delivery service inherently provided by CDNs, including, but not limited to a unified application service.

Although the disclosure is not limited in this regard, the term “CDN Service” as used herein, may relate to, or include each service a CDN of a Multi-CDN may provide, including, but not limited to, an application service or a content delivery service.

Although the disclosure is not limited in this regard, the term “Unified Service” as used herein, may relate to, or include a service which may be applied or operated in a consistent manner or in a uniform manner across all the different CDNs of a Multi-CDN.

Although the disclosure is not limited in this regard, by using the term “or” when listing two or more items or options, it is meant that each item, each plausible or feasible combination of the listed items including a combination of all listed items may be considered.

The terms “Edge Computing”, “Edge Compute” or “Edge Computing Technology” may be used interchangeably herein. These terms may relate to or include the ability to run custom code on edge servers or CDNs. Although the disclosure is not limited in this regard, the term “CDN” may also refer to the associated “CDN Provider” and vice versa, depending on context.

CDNs or CDN providers (e.g., Cloudflare™, Fastly™ or CloudFront™) may provide various services. Typically, a CDN will provide a stack of inherent traffic delivery services, which directly and particularly relate to traffic delivery, such as handling of HyperText Transfer Protocol (HTTP) requests and caching of content at the edge servers. On top of that, a CDN may provide one or more application services, such as services relating to security, traffic control or content processing. However, when employing multiple different CDNs, i.e., a Multi-CDN architecture, there are differences in the services provided, and in application services, in particular, between the different CDNs. For example, CDN architectures are different from one another. In order to work with multiple CDNs (Multi-CDN), one should integrate his solution with each one of the CDNs. Integrating different content delivery services is not an easy task, and integrating different application services may be even more challenging. Furthermore, when employing a Multi-CDN, none of the CDNs is provided with all the relevant information. For example, if traffic is divided between multiple CDN providers, each provider “sees” only a portion of the traffic. Following that, application services like security and traffic-control, which require seeing the ‘entire picture’ to work properly or work at all, might work less efficiently or stop working. In addition, operating multiple CDNs provided by multiple CDN providers in parallel (i.e., operating a Multi-CDN), may create a significant overhead for the user's or customer's organization. In spite of its prominent advantages, each one or a combination of the above may pose a large barrier for adopting a Multi-CDN architecture.

Recently, CDN providers have been introducing a new compute capability as part of their edge services. This new capability allows customers to execute their own custom code on the CDN servers and control the behavior of the traffic. This edge computing technology and capabilities are leveraged, inter alia, by disclosed systems and methods, to provide unified services (e.g., application services or content delivery services) which may provide, e.g., a uniform or consistent service across all CDNs in a Multi-CDN architecture. Moreover, the edge computing technology is leveraged by disclosed systems and methods to upgrade the maximal level of service capabilities which may be provided by a Multi-CDN. In addition, disclosed systems and methods may allow a user to manage or operate a Multi-CDN platform as a single CDN. Thus, the disclosed systems and methods may allow CDN users or customers to operate in a Multi-CDN architecture in a more simple and efficient manner, and moreover, to optimize or upgrade the service capabilities of the Multi-CDN platform.

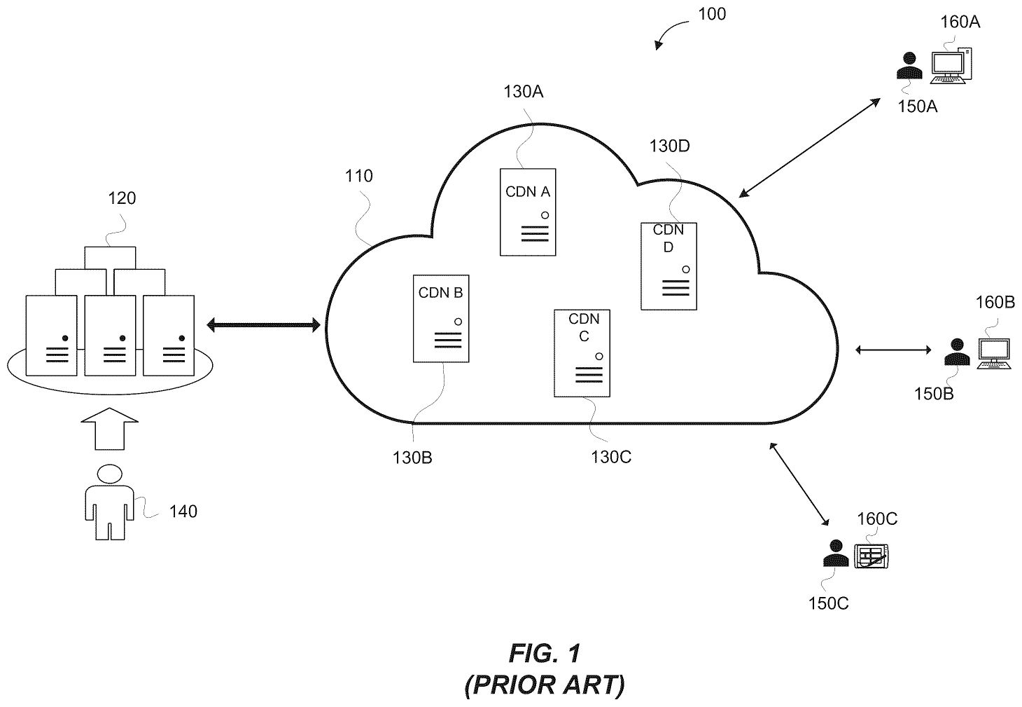

Referring to FIG. 1, there is shown a diagram of an exemplary Multi-CDN layout 100. Layout 100 comprises a cloud 110. Cloud 110 may include one or more clouds. Cloud 110 hosts An exemplary number of four CDNs: CDN A, also indicated 130A, CDN B, also indicated 130B, CDN C, also indicated 130C and CDN D, also indicated 130D forming a Multi-CDN. The Multi-CDN may include two or more CDNs. The Multi-CDN is in communication with origin servers or data centers 120. Data centers 120 are owned by or store the data of a user 140 of the Multi-CDN. User 140 may be, for example, a content provider. End-users such as end-user 150A, end-user 150B and end-user 150C, communicate with CDNs of the Multi-CDN such as CDN A 130A, CDN B 130B, CDN C 130C and/or CDN D 130D via computing devices such as computing devices 160A, 160B and 160C, respectively. Computing devices 160A, 160B and 160C include one or more input devices and one or more output devices. Computing device 160A is a desktop computer further including a hardware processor and a memory device. Computing device 160B is a terminal, e.g., of an organizational network, connected with a server, e.g., via an intranet. Computing device 160C is a handheld device, such as a tablet computer or a smartphone, further including a hardware processor and a memory device. The one or more input devices may include, for example, a mouse, a keyboard, a touch screen or pad, or any other type of input device. The one or more output devices may include visual output devices such as monitors, screens, or displays. End-users 160A, 160B and 160C consume, for example, content provided by datacenters 120 via the Multi-CDN.

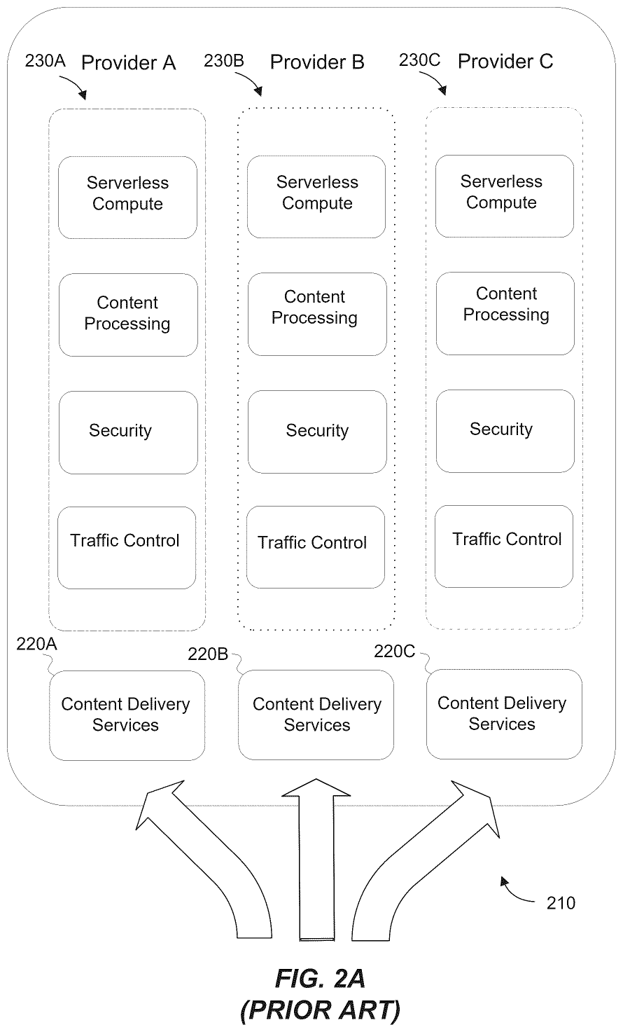

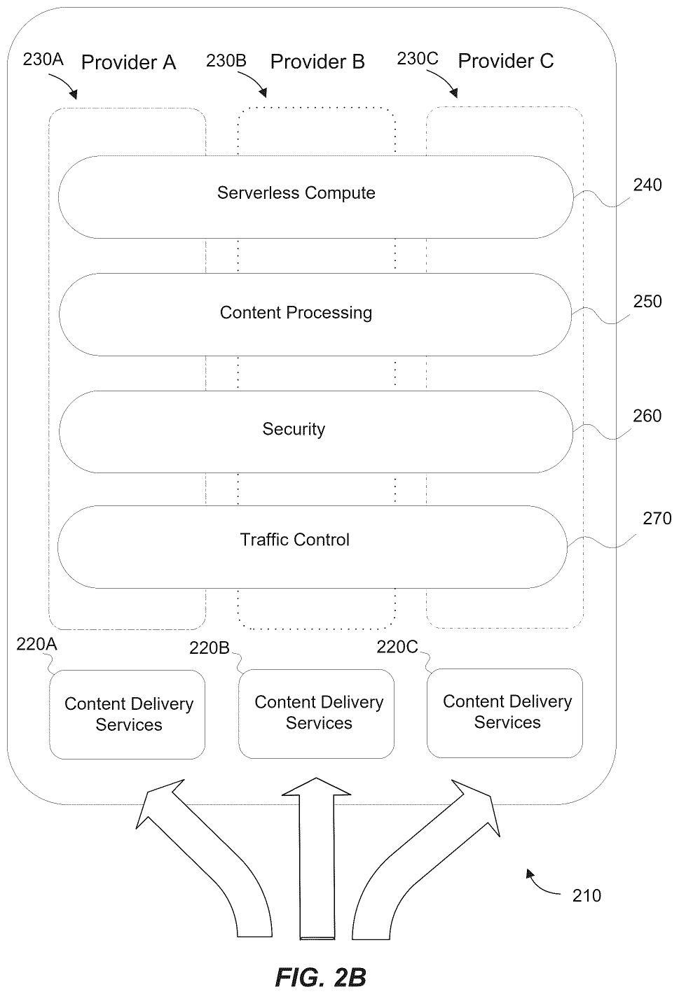

Reference is now made to FIG. 2A, which shows an illustration of exemplary services such as content delivery, traffic control, security, content processing and serverless compute which may be available by different CDNs, according to prior art. Referring to an exemplary Multi-CDN which includes three CDNs, such as CDN A, CDN B and CDN C of FIG. 1, each CDN is provided by a different provider: Provider A indicated 230A, Provider B, indicated 230B and Provider C indicated 230C, respectively. All the CDN providers provide content delivery services indicated 220A, 220B and 220C, respectively, to the Multi-CDN user, such as user 140 of FIG. 1. According to some aspects, content delivery services 220A, 220B and 220C may provide a substantially similar content delivery service. According to some aspects, there may be one or more differences between content delivery services 220A, 220B and 220C. Traffic entering the Multi-CDN and passing through the multiple different CDNs of the Multi-CDN is indicated 210. Each provider of providers A, B and C may provide the indicated exemplary application services: serverless compute, content processing, security, and traffic control. However, each application service is not consistent and is different across the different CDN providers and their respective CDNs. Furthermore, not all the CDN providers of a Multi-CDN may provide a specific application service. This prevents a Multi-CDN user, such as user 140, from using the application services provided by the different CDN providers in a Multi-CDN architecture. It may also act as a barrier to adoption of a Multi-CDN architecture by a CDN user, to begin with. Lack of uniformity or unity between the services provided by different CDNs (or by different CDN providers) inhibits the interoperability and portability of services, which may lead to what is referred to as a “vendor lock-in”.

Referring to FIG. 2B, there is shown an illustration of exemplary unified application services: serverless compute 240, content processing 250, security 260 and traffic control 270, which may be provided to the Multi-CDN layout or architecture of FIG. 2A while utilizing systems or methods of the disclosed systems and methods. In this Figure, the Multi-CDN is provided with the indicated unified application services, while each unified application service such as: serverless compute 240, content processing 250, security 260 and traffic control 270 is e.g., uniform and/or consistent (e.g., displaying the same behavior) across the Multi-CDN (e.g., on each CDN of the Multi-CDN). As far as the Multi-CDN user is concerned, the identity or the differences between the different CDN providers (such as provider 230A, provider 230B and provider 230C) and their respective CDNs become transparent, by that acting as a single CDN.

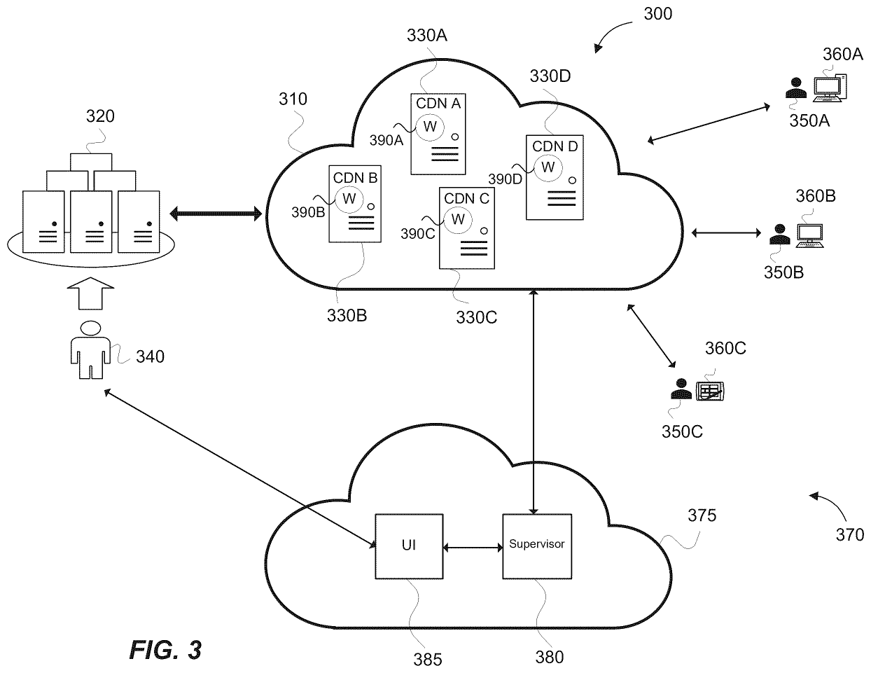

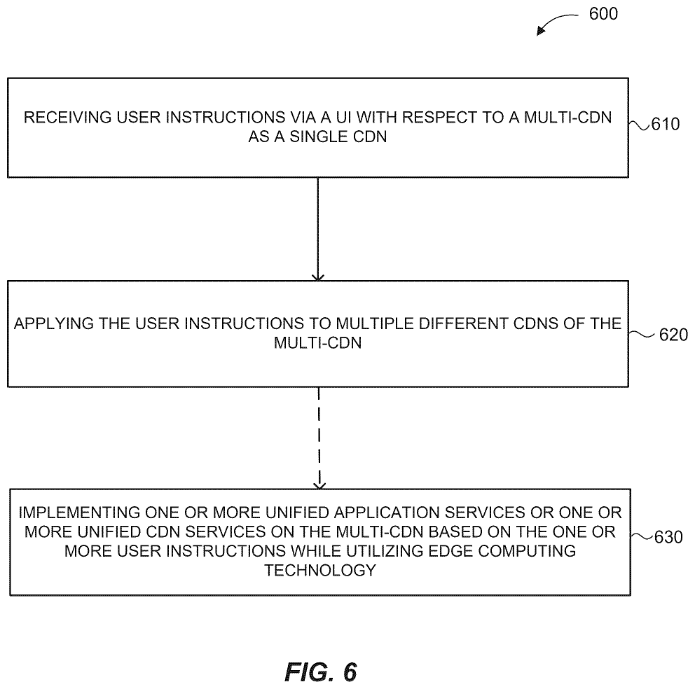

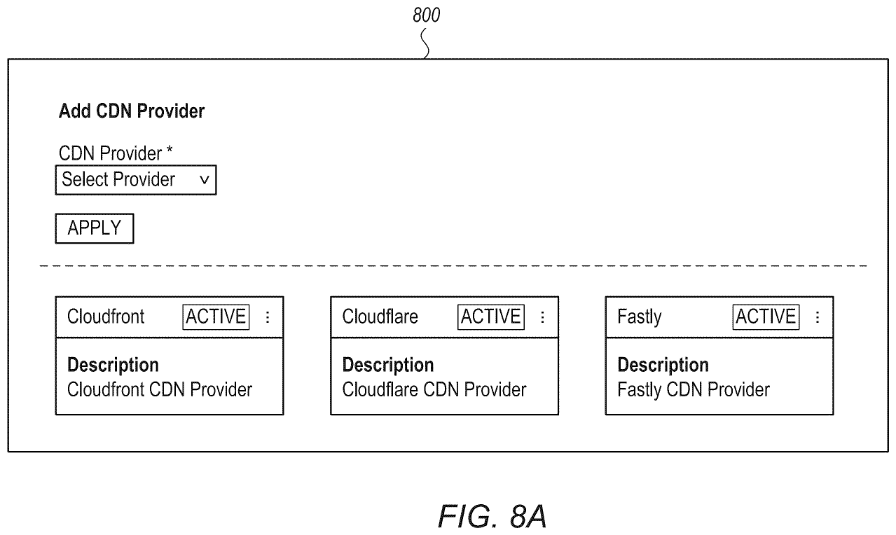

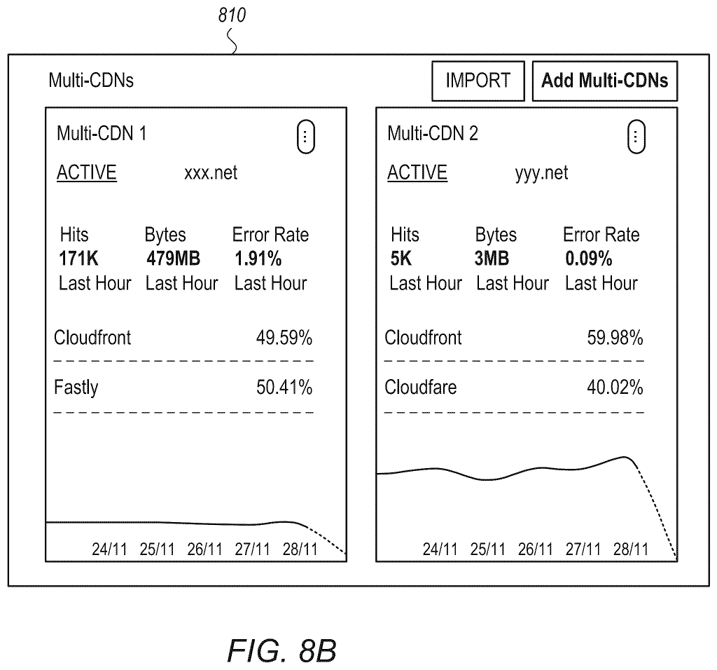

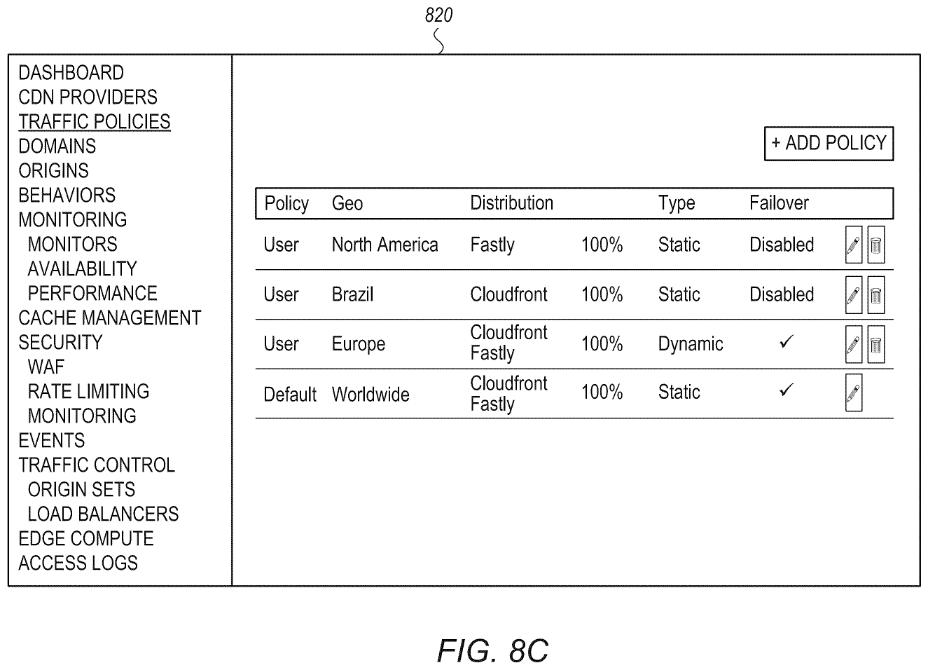

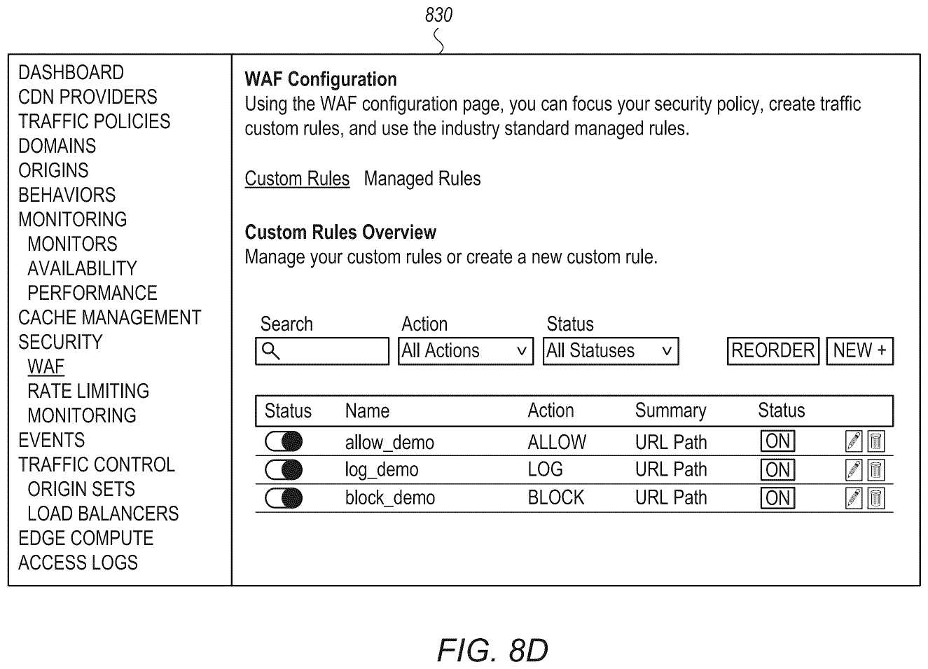

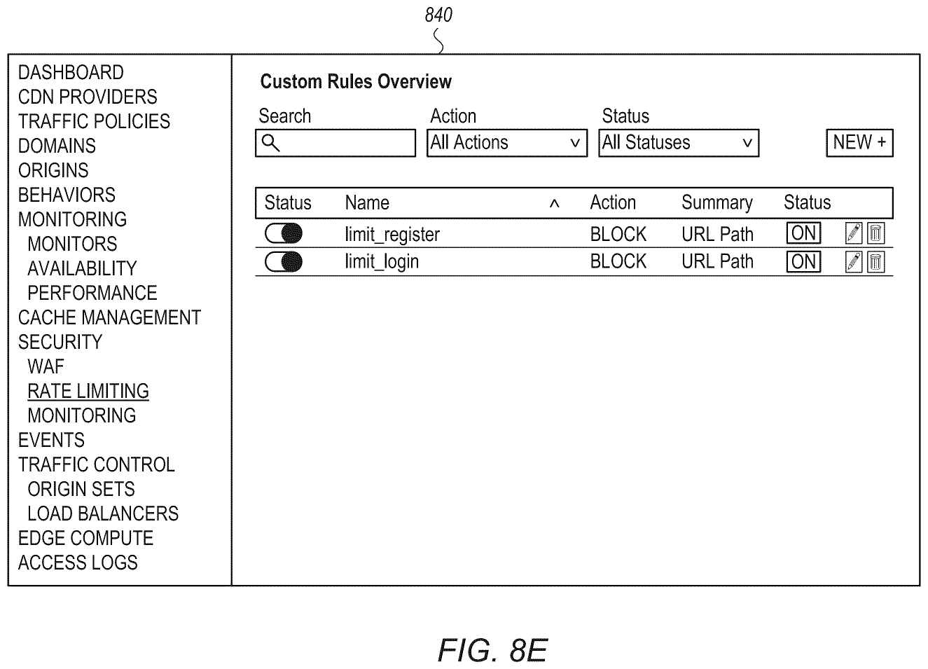

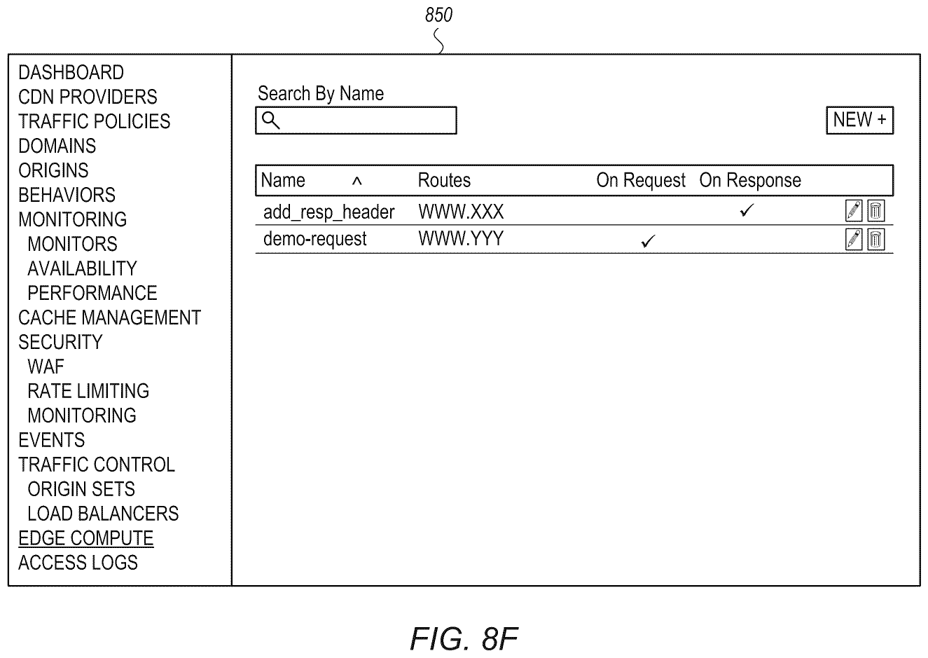

Reference is now made to FIG. 3, which is a diagram of an exemplary system 370 for management and/or upgrading of an exemplary Multi-CDN layout 300. Multi-CDN layout (or Multi-CDN or layout) 300 is similar to Multi-CDN layout 100 of FIG. 1. Layout 300 employs or utilizes system 370. System 370 may include a supervisor component (or supervisor) 380 and a User Interface (UI) 385. Supervisor 380 and UI 385 may be stored and/or executed on a cloud platform (or cloud) 375. Cloud 375 may include one or more cloud platforms. Additionally, or alternatively, at least one of supervisor 380 and UI 385 may be stored on other platforms, such as one or more local servers. UI 385 is configured to be in communication with supervisor 380. Multi-CDN user 340, which may be similar to Multi-CDN user 140 of FIG. 1, may have access to, communicate and/or interact with UI 385 to provide instructions to system 375 and optionally receive data with respect to the operation of Multi-CDN 300. Supervisor 380 is in communication with Multi-CDN 300. Supervisor 380 receives information with respect to the entire traffic passing through Multi-CDN 300 and may receive decisions based on such information. Worker agents 390A, 390B, 390C and 390D are each deployed and executed (e.g., thus generating instances of the worker agents) on platforms of CDN A (indicated 330A), CDN B (indicated 330B), CDN C (indicated 330C) and CDN D (indicated 330D) of Multi-CDN 300, respectively. It should be noted that a CDN such as CDN A, B, C or D of a Multi-CDN such as Multi CDN 300 may include multiple worker agents, and worker agents 390A, 390B, 390C and 390D are merely representative. According to some aspects, worker agents 390A, 390B, 390C and 390D are based on server-less edge-computing. According to some aspects, worker agents 390A, 390B, 390C and 390D are included in system 370. Supervisor 380 is configured to be in communication with each of worker agents 390A, 390B, 390C and 390D. Supervisor 380 may provide instructions to each of worker agents 390A, 390B, 390C and 390D. Worker agents 390A, 390B, 390C and 390D may then apply the instructions on the traffic passing through Multi-CDN 300, respectively. Supervisor 380 may receive reports and/or other data from each of worker agents 390A, 390B, 390C and 390D. The reports and/or data may refer, for example, to the traffic passing through each of CDNs 330A, 330B, 330C and 330D, respectively. According to some aspects, a worker agent may be adapted to run on a specific CDN (e.g., of a specific CDN provider). Supervisor 380 may receive instructions from user 340 via UI 385 and may provide reports and/or data to user 340 via UI 385. According to some aspects, supervisor 380 may be in communication with one or more CDNs of Multi-CDN 300, e.g., via Application Program Interfaces (APIs). According to some aspects, UI 385 may provide user 340 with an orchestration or management tool to orchestrate or manage Multi-CDN 300 and/or worker agents such as worker agents 390A, 390B, 390C and 390D, as will be detailed hereinbelow. According to some aspects, UI 385 may provide user 340 with a unified management tool for managing Multi-CDN 300, including each of CDNs A, B, C and D, in a unified and simple manner, as will be further detailed or exemplified below, e.g., with respect to FIGS. 6 and 8A-8F. Each method of the methods detailed hereinbelow may be practiced or applied by a system such as system 370.

According to some aspects, different CDNs of the multiple different CDNs of a Multi-CDN, such as CDNs A, B, C, and D of Multi-CDN 300, have at least one different characteristic such as a different architecture, different API, different implementation of one or more application services, or different programming language support. For example, at least one CDN of CDNs A, B, C and D may have at least one such characteristic different from the rest of the CDNs. According to some aspects, at least one CDN of the Multi-CDNs, such as CDNs A, B, C and D, is provided by a different CDN provider. According to some aspects, each CDN of the Multi-CDNs, such as CDNs A, B, C and D, is provided by a different CDN provider.

With reference to FIGS. 2A and 2B, CDNs A, B, C and D of Multi-CDN 300 may be provided by different CDN providers such as providers A, B and C of FIGS. 2A and 2B. CDNs A, B, C and D may provide content delivery services such as content delivery services 220A, 220B and 220C. Each CDN of CDNs A, B, C and D of the respective CDN providers may be capable of providing one or more application services such as traffic control, security, content processing or serverless compute. However, an application service provided by a specific CDN or by a specific CDN provider is limited to the specific CDN or CDN provider. System 370 may then enable Multi-CDN 300 to provide a unified, e.g., consistent or uniform, one or more application services across different CDNs A, B, C and D, such as unified serverless compute application services 240, unified content processing application services 250, unified security application services 260, or unified traffic control application services 270.

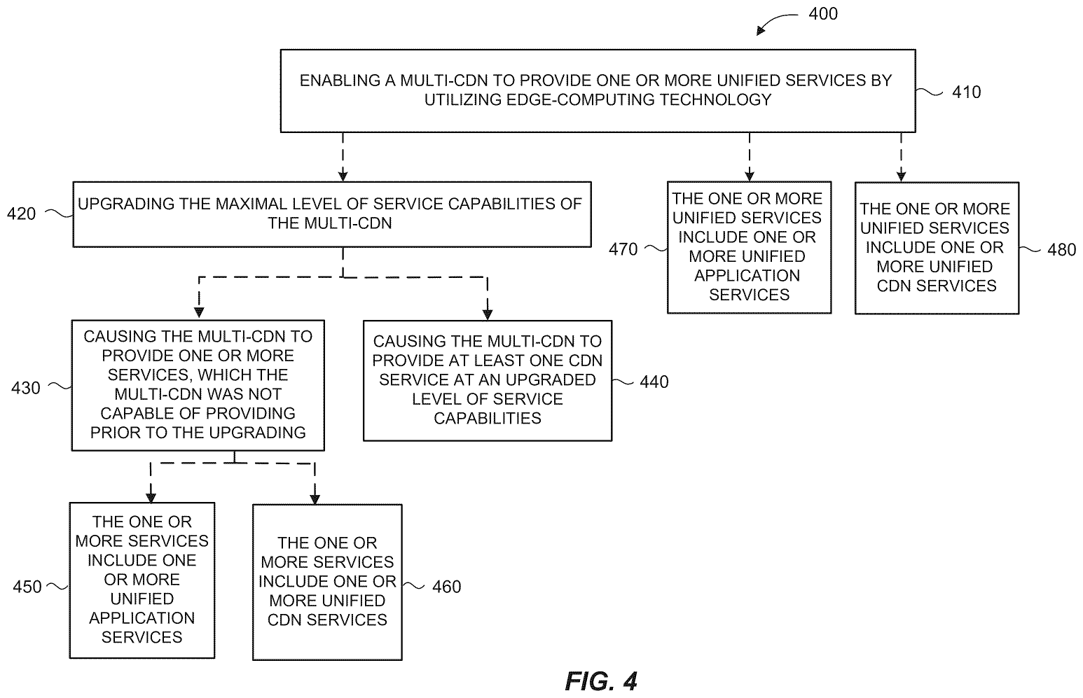

Reference is now made to FIG. 4, which shows a diagram 400 exemplifying different manners for enabling a Multi-CDN to provide one or more unified services. The Multi-CDN includes multiple different CDNs, e.g., provided by multiple different CDN providers. At least one CDN of the multiple different CDNs of the Multi-CDN employs edge computing technology which enables the user to execute custom code on platforms of the respective CDN or CDNs. According to some aspects, a plurality of the CDNs of the multiple different CDNs employ edge computing technology. According to some aspects, the multiple different CDNs (i.e., all the CDNs of the Multi-CDN) employ edge computing technology. According to some aspects, one or more, but not all, of the CDNs of the Multi-CDN may not employ edge computing technology.

In an initial or basic phase 410, enabling a Multi-CDN, such as Multi-CDN 300 of FIG. 3, to provide one or more unified services is performed by utilizing edge computing technology. Enabling the provision of a unified service may be performed, for example, via one or more CDNs of the Multi-CDN, which require, e.g., an upgrade or a modification, to the service they provide. Such an upgrade or modification may be performed via edge computing capabilities provided by each one of these one or more CDNs.

The one or more unified services may be or may include unified application services or unified CDN services. According to some aspects, the unified services provide substantially the same service or a consistent or a substantially consistent service via or across the multiple different CDNs of the Multi-CDN. Lack of unity or consistency in a service between different CDNs of a Multi-CDN may be expressed in various manners. For example, lack of consistency may exist when providing different features in a service or different level of service capabilities (e.g., when one or more CDNs enable performing URL redirect while one or more other CDNs do not enable performing URL redirect); by returning different status code values for a certain service applied in response to a user request; by having a different behavior (e.g., the Web Application Firewall (WAF) service of one or more CDNs allows a specific type of requests while the WAF service of one or more other CDNs does not allow this specific type of requests); or by not providing a specific service (e.g., one or more CDNs provide an image and video optimization application service while one or more other CDNs do not provide such a service).

According to some aspects, a unified application service may utilize, receive, or operate based on information with respect to a plurality of CDNs of the Multi-CDN or based of information referring to or received from the entire Multi-CDN. For example, a rate limiting service would require information from all CDNs in a Multi-CDN architecture to work properly. However, a rate limiting application service provided by a specific CDN provider would receive or operate based on information referring to traffic passing through the specific CDN. Thus, a unified rate limiting application service which utilizes, receives, or operates based on information referring to the traffic passing through the Multi-CDN (e.g., including traffic passing through each CDN of the Multi-CDN) may be highly desired.

According to some aspects, the Multi-CDN may provide a user, such as user 340 of FIG. 3, with a maximal level of service capabilities. The maximal level is the highest common denominator of level of service capabilities provided by the multiple different CDNs. According to an option 420, the unifying of one or more services includes upgrading the maximal level of service capabilities of the Multi-CDN. The upgrading may be performed in various manners, as will be exemplified herein below.

According to an option 430, the upgrading of the maximal level of service capabilities of the Multi-CDN includes causing the provision of one or more services, which the Multi CDN was not capable of providing prior to the upgrading. A Multi-CDN may not be capable of providing a service (e.g., an application service or a content delivery service), for example, when one or more CDNs of the Multi-CDN do not provide the service, when the service, as provided by two or more different CDNs of the Multi-CDN, behaves differently, or when the service requires information relating to traffic passing through more than a single CDN.

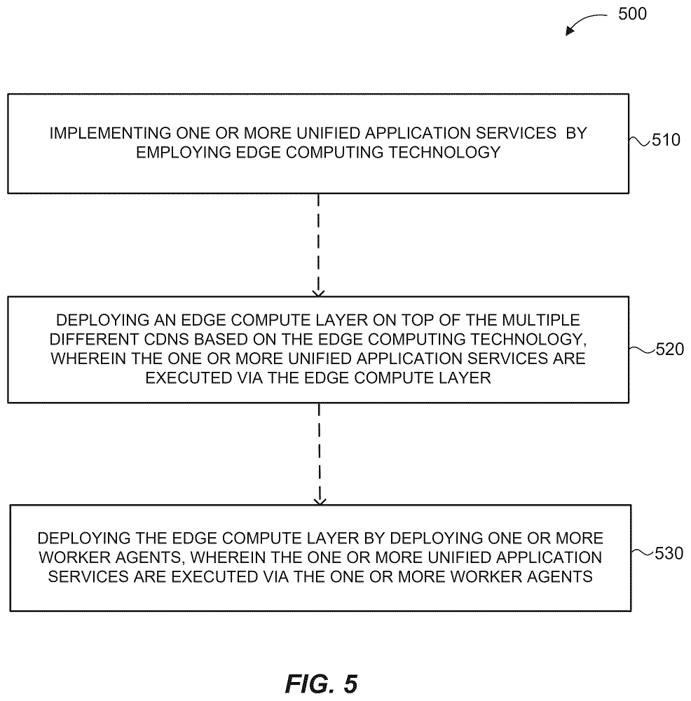

According to an option 450, the one or more added services (e.g., services which were not provided previously) include one or more unified application services. The unified application services are services provided by the disclosed systems and methods to be executed on platforms of all the CDNs of the Multi-CDN. Following that, it is required that all the CDNs of the Multi-CDN employ edge computing technology. The addition or implementation of unified application services in a Multi-CDN, may be performed, for example, according to method 500 of FIG. 5.

Unified application services may provide different types of services. According to some aspects, the types of services which may be provided by a unified application service may be selected from: security, edge-computing, traffic control or content processing. According to some aspects, a unified security application services may be an application service selected from: WAF, bot detection, rate-limiting, Distributed Denial-of-Service (DDoS) protection, API security, client reputation, or anomaly detection. According to some aspects, a unified traffic control application service may be an application service selected from: origin load balancing or origin routing. According to some aspects, a unified content processing application service may be an application service selected from: image and video optimization or image and video manipulation.

According to an option 460, in addition to or as an alternative to option 450, the one or more services include one or more CDN services (e.g., content delivery services). A Multi-CDN may be upgraded in such a manner when a portion of the multiple different CDNs (e.g., one or more of the CDNs, but not all) is not capable of providing the CDN service and the rest of the multiple different CDNs (e.g. one or more CDNs, but not all) are capable of providing the CDN service. Accordingly, the portion of the CDNs not capable of providing the CDN service are required to employ or provide edge computing capabilities. The upgrading of the level of capabilities of the Multi-CDN may then include causing the portion of CDNs to provide the CDN service by utilizing the edge computing technology employed by the portion of CDNs, respectively.

According to option 440, in addition to or as an alternative to option 430, systems and methods of the disclosed systems and methods may cause or enable the Multi-CDN to provide at least one CDN service at an upgraded level of service capabilities, e.g., by modifying or upgrading the CDN service, to be a unified CDN service. Such upgrading may be performed, for example, when each CDN of the multiple different CDNs of the Multi-CDN is capable of providing a CDN service at a certain level of service capability and at least one CDN of the multiple different CDNs is capable of providing the CDN service at a different levels of service capability. The Multi-CDN may then provide the user, at most, with the CDN service at the lowest level of service capabilities of the different levels of service capabilities of the different CDNs. Upgrading of the level of capabilities of the Multi-CDN may include enabling the Multi-CDN to provide the CDN service at an upgraded level of service capability, higher than the lowest level of service capability provided by the CDNs of the Multi-CDN. With reference to FIG. 3, CDN A of Multi-CDN 300, for example, may provide a CDN service at a level lower than the level which may be provided by each one of CDNs B, C and D, e.g., by not providing an additional feature of the service which is provided by the rest of the CDNs. Multi-CDN 300 may then provide the service at the lowest level available, i.e., at the level available by CDN A and without the additional feature. According to systems and methods of the disclosed systems and methods, edge computing technology employed by CDN A may be utilized to cause CDN A to provide the additional feature as part of the provided CDN service. Multi-CDN 300 may then provide the CDN service with the additional feature, and thus provide an upgraded level of the CDN service.

It should be noted that a Multi-CDN may provide a user, de facto, with a level of service capabilities lower than the lowest level provided by the multiple different CDNs (e.g., due to a user selection to opt out a service or a feature of the service available via the Multi-CDN). Thus, according to some aspects, the upgraded level of service capability to be provided by the Multi-CDN may be selected from different available levels (e.g., by the user).

Upgrading of the level of service capabilities of the Multi-CDN may be performed by enabling the one or more CDNs which may provide the CDN service at a level of service capability lower than the upgraded level of service capability to provide the CDN service at the upgraded level of service capability. In such a case, the one or more CDNs, capable of providing the CDN service at a level lower than the upgraded level of service capability, employ edge computing technology.

According to options 470 and 480, the unified one or more services enabled by the disclosed systems and methods may include one or more unified application services (option 470) or unified CDN services (option 480), while enabling the provision of such services by the Multi-CDN does not necessarily include or does not include upgrading of the maximal level of service capabilities of the Multi-CDN as in option 420. For example, different CDNs of a Multi-CDN may provide different values for the same status indication. Such different notifications or behavior may require some adaptations from the user's side in order for the user's business or environment to work properly. Providing a unified CDN service, which, for example, outputs the same values for the same status indications may prevent the client the overhead of making the necessary adaptations. Each of options 470 or 480 may be applied or performed in addition to or alternatively to option 420.

All the options described with respect to FIG. 4 may be applied or practiced via systems and methods of the disclosed systems and methods in an alternative or joint manner. FIG. 4 is exemplary and other variations and applications are contemplated to be within the scope of the present disclosure.

According to some aspects, systems and methods of the disclosed systems and methods, may provide, alternatively or additionally, management of the multiple different CDNs, such as CDNs A, B, C, and D of Multi-CDN 300 of FIG. 3, in a unified or consistent manner, e.g., via a unified management system. According to some aspects, such a unified management system may be or may be included in system 370 of FIG. 3. According to some aspects, providing unified management of the multiple different CDNs, e.g., of a Multi-CDN, includes allowing management of the multiple different CDNs as a single CDN. According to some aspects, the unified management of the multiple different CDNs comprises receiving user instructions via a UI, such as UI 385 of FIG. 3. According to some aspects, the unified management of the multiple different CDNs includes allowing management of services executed on the multiple different CDNs. According to some aspects, the services may include or may be selected from CDN services, unified services or a combination thereof. According to some aspects, the unified management system is configured to communicate with a supervisor component, such as supervisor 380 of FIG. 3. According to some aspects, the supervisor component may be configured to communicate with the multiple different CDNs. According to some aspects, the unified management system includes a single API.

According to some aspects, automatic selection of the multiple different CDN providers may be provided. The selection of the multiple different CDN providers may be based on at least one of performance, availability or cost of the services provided by the CDN provider, or a combination thereof.

Reference is now made to FIG. 5, which is a flow diagram of a method 500 for providing unified application services on top of multiple different CDNs or a Multi-CDN, such as Multi-CDN 300 of FIG. 3. Disclosed systems and methods enabling a Multi-CDN to provide one or more unified application services may include or may apply the steps of method 500.

In a step 510, one or more unified application services, which are, for example, consistent across the multiple different CDNs of the Multi-CDN, are implemented by employing edge computing technology.

In an optional step 520, an edge compute layer may be deployed on top of the multiple different CDNs platforms based on the edge computing technology employed by the multiple different CDNs. The one or more unified application services may then be implemented via the edge compute layer.

In an optional step 530, the edge compute layer may be deployed via one or more worker agents, such as worker agents 390A, 390B, 390C and 390D of FIG. 3. The method may further include the step of installing each worker agent of the one or more worker agents on a platform of a CDN of the multiple different CDNs via the edge computing technology, respectively. One or more unified application services may be then executed on the multiple CDNs platforms via the one or more worker agents. According to some aspects, multiple worker agents may be installed on platforms of a CDN. According to some aspects, the one or more worker agents are further configured to report to a supervisor component, and to receive instructions from the supervisor component to be applied to the multiple different CDNs, respectively. According to some aspects, a worker-agent is a software-based component. According to some aspects, a worker agent may be based on serverless computing and edge-computing technology. According to some aspects, a worker agent may provide data with respect to traffic passing through the CDN on which the worker agent is installed required for the operation of the one or more unified application services. According to some aspects, when an update to the one or more worker agents is required, the method may further include the step of gradually deploying one or more updated worker agents while monitoring error reports following the deployment. Such a gradual deployment may increase the resiliency of the entire system. According to some aspects, a unified application service of the one or more unified application services may utilize corresponding one or more application services offered or which may be provided by one or more CDN providers of the Multi-CDN.

According to some aspects, the one or more unified application services may include a unified edge-computing application service. The unified edge-computing application service may provide a unified programming language and may include at least one of one or more APIs, a runtime environment, a shared persistent state, or a combination thereof. A shared persistent state may be a persistent state shared and accessible by the multiple different CDNs of a Multi-CDN. An example for providing a user with a unified edge computing application via a GUI is shown in FIG. 8F, as will be detailed hereinbelow. The unified edge-computing application service may allow a user to enter custom code once in a predefined unified programming language as in a single CDN. The unified edge-computing application service (e.g., via systems and methods of the disclosed systems and methods) may then apply the code to each CDN of the Multi-CDN as a single CDN. According to some aspects, the code entered by the user may be adapted or translated, as necessary, by the disclosed systems and methods to be executed on each CDN of the Multi-CDN. According to some aspects, the method may further include the steps of receiving a piece of code written in the unified programming language entered by the user and causing the system to test the piece of code.

According to some aspects, each unified application service may include one or more pieces of code. A unified application service may include a plurality of corresponding pieces of code while each piece of code is adapted to be executed on one or more specific CDNs of the Multi-CDN. According to some aspects, a failure of a unified application service would not disturb traffic flow through respective one or more CDNs of the multiple different CDNs.

Reference is now made to FIG. 6, which is a flow diagram of a computerized method 600 for providing a unified management of a Multi-CDN, such as Multi-CDN 300 of FIG. 3. The Multi-CDN includes multiple different CDNs, such as CDNs A, B, C and D, of Multi-CDN 300, e.g., provided by multiple different CDN providers. At least a plurality of CDNs of the Multi-CDN employ edge computing technology which enables a user of the Multi-CDN, e.g., user 340 of Multi-CDN 300, to execute custom code on a platform of the respective CDN.

In a step 610, user instructions are received via a UI, e.g., UI 385 of system 370, with respect to the Multi-CDN, as a single CDN. Thus, for example, the user may not be required to provide instructions or handle each CDN in a separate manner. The user may not be required to adapt his instructions or his systems to each CDN of the Multi-CDN, e.g., to be compatible with the specific CDN architecture or configuration. Reference is also made to FIGS. 8A-8F which exemplify unified management of a Multi-CDN via a GUI, including management of unified services and CDN services, as will be detailed herein below.

In a step 620, the user instructions to the Multi-CDN are applied to the different CDNs of the Multi-CDN. According to some aspects, the user instructions are adapted to CDNs of the Multi-CDN, as necessary.

In an optional step 630, one or more unified application services or one or more unified CDN services may be implemented on the platforms of different CDNs of the Muti-CDN or enabled by the Multi-CDN via edge computing technology. The enabling or the provision of unified application services or the unified CDN services may be based on the user instructions. According to some aspects, each service provided by each unified application service or each unified CDN service is consistent across the Multi-CDN. According to some aspects, the user may manage the one or more unified services via the UI.

According to some aspects, the unified management may include management of CDN services or management of unified CDN services. According to some aspects, the disclosed Multi-CDN unified management may, inter alia, allow management of CDN services, unified application services or unified CDN services.

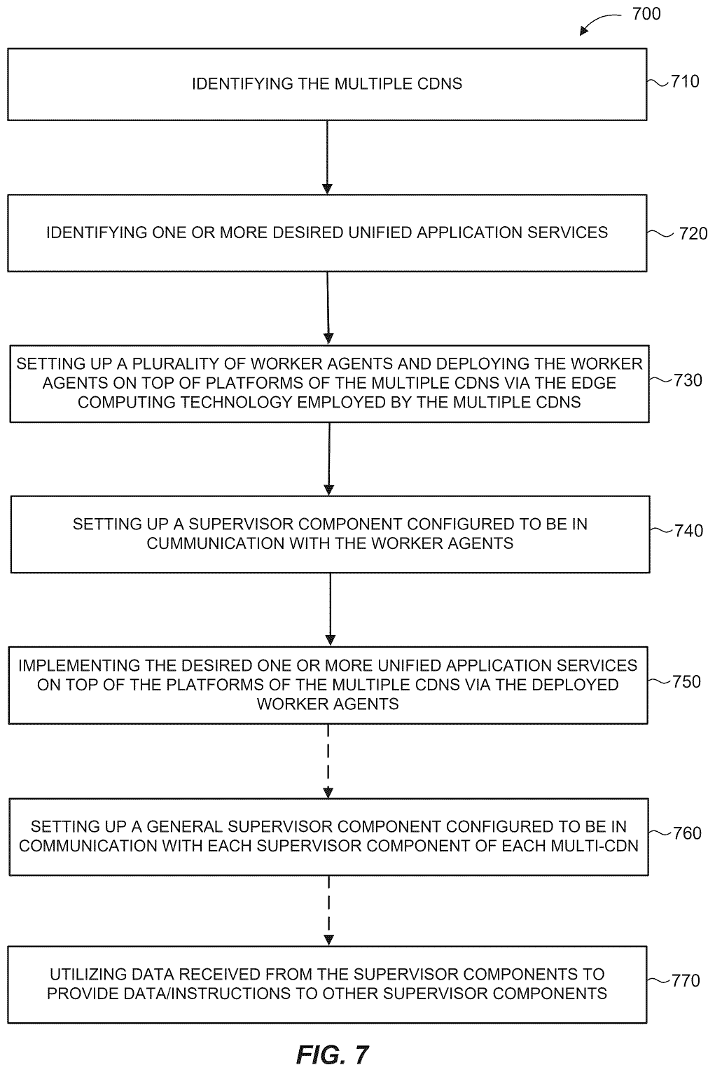

Reference is now made to FIG. 7, which is a flow diagram of a computerized method 700 for providing unified application services on top of one or more Multi-CDNs such as Multi-CDN 300 of FIG. 3. Each Multi-CDN of the Multi-CDNs includes multiple different CDNs, e.g., provided by multiple different CDN providers. Each CDN of each Multi-CDN employs edge computing technology which enables users of the Multi-CDNs to execute custom code on a platform of each CDN of each Multi-CDN, respectively. For each Multi-CDN, the method may include the following steps. Specifically referring to FIG. 3, system 370 may be in communication with multiple Multi-CDNs like Multi-CDN 300 and may serve multiple users like user 340. According to some aspects, a single user like user 340 may be using multiple Multi-CDNs. According to some aspects, systems and methods of the disclosed systems and methods may serve multiple users like user 340, while each user may utilize one or more Multi-CDNs like Multi-CDN 300. Reference is also made to FIGS. 8A-8F, which show screen shots of pages of an exemplary GUI. The GUI may be included, for example, in a UI such as UI 385 of FIG. 3. The GUI may include a dashboard as shown, for example, in FIGS. 8A-8F.

In a step 710, identification of the multiple different CDNs of the Multi-CDN is obtained, e.g., by obtaining a list of the CDNs. According to some aspects, the CDNs may be selected by the user, e.g., by selecting a CDN provider. The user selection may be performed via a UI, such as UI 385. Reference is now made to FIG. 8A, which shows a screenshot of a page 800 of the GUI. In this page the user may select or add CDN providers for a Multi-CDN. Page 800 specifically shows three selected CDN providers for a Multi-CDN: CloudFront™, Cloudflare™ and Fastly™ According to some aspects, the CDN providers may be selected via the disclosed systems and methods. Reference is now made to FIG. 8B, which shows another screen shot of a page 810 of the GUI allowing a user to add Multi-CDNs. Page 810 specifically shows two Multi-CDNs already added “Multi-CDN 1” and “Multi-CDN 2” and presents the user with information referring to the activity or operation of each Multi-CDN and each CDN (presented by CDN provider) of each Multi-CDN.

In a step 720, identification (e.g., a list) of one or more desired unified application services are obtained. The desired unified application services may be entered or provided by a user, e.g., via the UI.

In a step 730, a plurality of worker agents, such as worker agents 390A, 390B, 390C and 390D of FIG. 3, are set up and deployed on top of platforms of the multiple different CDNs of the Multi-CDN. The worker agents are deployed via the edge computing technology employed by the multiple different CDNs, respectively. According to some aspects, each worker may include a package of one or more unified application services, where each unified application service is to be executed on the respective CDN platform, once activated.

In a step 740, a supervisor component (e.g., a software-based component), such as supervisor 380, is set up. The supervisor is configured to be in communication with the plurality of worker agents to receive reports from the worker agents and provide instructions to the worker agents with respect to traffic passing through the multiple different CDNs of the Multi-CDN, respectively. The worker agents may apply various operations to the traffic passing through the relevant CDN according to the instructions received from the supervisor component.

In a step 750, the desired one or more unified application services are implemented across the Multi-CDN via the deployed plurality of worker agents.

According to some aspects, the method may further include an optional step 760 according to which a general supervisor component configured to be in communication with each supervisor component of each Multi-CDN of the Multi-CDNs is set up. According to some aspects, the method may further include an optional step 770 according to which data received from one or more supervisor components of respective one or more Multi-CDNs of the Multi-CDNs is utilized to provide data or instructions to at least one supervisor component other than the one or more supervisor components. According to some aspects, a user may have or may manage multiple Multi-CDNs. A general supervisor component may be then set up per a user. The user's general supervisor may be in communication with each supervisor component of each Multi-CDN of the client. According to some aspects, a general supervisor may be set up and configured to be in communication with the users' general supervisors in case such user general supervisors exist.

The above detailed methods may be applied or performed by using a system such as system 370 of FIG. 3.

Reference is now made to FIG. 8C. FIG. 8C shows a screen shot of a page 820 of the GUI for managing or determining traffic policies of Multi CDNs. Page 820 displays to the user the distribution of traffic per CDN and geography.

Reference is now made to FIGS. 8D-8F, which refer to setting or configuring unified application services according to the disclosed systems and methods. According to some aspects, the GUI (or the UI such as UI 385) may allow a user to set or configure unified application services, such as WAF, rate limiting or edge compute.

Reference is now made to FIG. 8D which shows another screen shot of a page 830 of the GUI for configuring a security unified application service of WAF. WAF application service is aimed at filtering undesired traffic. Specifically, the GUI as shown in page 830 provides a user with two options for configuring a WAF, e.g., via managed rules or via custom rules. The feature of managed rules provides preset, preconfigured, or predefined rules that the user may select. Alternatively, or additionally, the user may define new custom rules. The disclosed systems and methods may apply the selected predefined rules or the custom rules in a consistent manner across the different CDNs of the Multi-CDN.

FIG. 8E shows another screen shot of a page 840 of the GUI for configuring a security unified application service of rate limiting. Rate limiting allows determining a strategy for limiting network traffic, e.g., by putting a cap on how often an end user, such as end users 360A, 360B and 360C of FIG. 3, can repeat an action within a timeframe (e.g., trying to log into an account). Specifically, the GUI as shown in page 840 provides a user with the option to set or configure a unified rate limiting application service by determining custom rules.

FIG. 8F shows yet a further screen shot of a page 850 of the GUI for creating custom code to be executed on the Multi-CDN via a unified edge compute application service. As shown in page 850, in particular, the user may create, generate, or add new custom code or functions to be applied to the Multi-CDN via the GUI. The custom code may be implemented by the user via a unified programming language (e.g., Java script). The edge computing unified application service may include at least one of one or more APIs, a runtime environment, a shared persistent state, or a combination thereof. Thus, the user may implement a desired code once, e.g., via the unified programming language. The unified edge-computing application service (e.g., via the disclosed systems and methods) may then apply the code to each CDN of the Multi-CDN as a single CDN. An additional page or screen may be included (e.g., as a pop-up window) which allows entering and editing code.

A computer program product for enabling a Multi-CDN according to the disclosure to provide one or more unified services is further disclosed. At least one CDN of the multiple different CDNs of the Multi-CDN employs edge computing technology which enables a user of the Multi-CDN to execute custom code on platforms of the at least one respective CDN. The computer product may include a computer-readable storage medium having computer-executable instructions for enabling the Multi-CDN to provide one or more unified services across the multiple different CDNs by utilizing the edge computing technology employed by the at least one CDN, where each unified service of the one or more unified services provides a consistent service across the multiple different CDNs. According to some aspects the computer-executable instructions included in the computer-readable storage medium may include instructions for causing a computing system, such as a server, a servers farm, a CDN, a Multi-CDN, a cloud, and the like to apply the disclosed methods including the methods of FIG. 4, method 500 of FIG. 5, method 600 of FIG. 6 and method 700 of FIG. 7. According to some aspects, the disclosed computer program product may be coupled with or integrated in the disclosed systems, causing them to operate according to its stored computer-executable instructions.

The disclosed systems may include a hardware processor (also referred herein as “processor”) or controller that may be or include, for example, one or more central processing unit processor(s) (CPU), one or more Graphics Processing Unit(s) (GPU or GPGPU), and/or other types of hardware processor (or processor), such as a microprocessor, digital signal processor, microcontroller, programmable logic device (PLD), field programmable gate array (FPGA), or any suitable computing or computational device.

The disclosed systems may also include an operating system, a memory, a storage device (also referred herein as “storage”), input devices, output devices, or a communication device. The operating system may be or may include any code designed and/or configured to perform tasks involving coordination, scheduling, arbitration, supervising, controlling or otherwise managing operation of computing systems, such as scheduling execution of programs. A storage or memory according to the disclosure may be, or may include, for example, one or more Random Access Memory (RAM), read-only memory (ROM), flash memory, volatile memory, non-volatile memory, cache memory, and/or other memory devices. The storage or memory may store, for example, executable instructions that carry out an operation (e.g., executable code) and/or data. Executable code may be any executable code, e.g., an app/application, a program, a process, task, or script. Executable code may be executed by the processor of the disclosed systems.

The storage may further be or include, for example, one or more of a hard disk drive, a solid-state drive, an optical disc drive (such as DVD or Blu-Ray), a USB drive or other removable storage device, and/or other types of storage devices. Data such as instructions, code, and procedure data, among other things, may be stored in the storage and may be loaded from the storage into a memory included in the storage where it may be processed by the processor. The input devices may include, for example, a mouse, a keyboard, a touch screen or pad, or another type of input device. The output devices may include one or more monitors, screens, displays, speakers and/or other types of output devices.

The illustrated components of the drawings are exemplary and variations are contemplated to be within the scope of the present disclosure. For example, the numbers of components may be greater or fewer than as described and the types of components may be different than as described. For example, when the disclosed systems implement a server system, a large number of central processing units or cores may be utilized. Other variations and applications are contemplated to be within the scope of the present disclosure.

The aspects described above are exemplary and variations are contemplated to be within the scope of the present disclosure.

Accordingly, systems and methods for managing, unifying, or upgrading Multi-CDNs have been described herein. For purposes of explanation, specific configurations and details are set forth in order to provide a thorough understanding of aspects of the disclosed technology. However, it is apparent to one skilled in the art that the disclosed technology can be practiced without using every aspect presented herein.

Different aspects are disclosed herein. Features of certain aspects can be combined with features of other aspects; thus, certain aspects can be combinations of features of multiple aspects.

While several embodiments of the disclosure have been described herein and/or shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A system for enabling a Multi-Content-Delivery-Network (Multi-CDN) to provide one or more unified services, the Multi-CDN comprising multiple different Content Delivery Networks (CDNs) provided by multiple different CDN providers, wherein at least one CDN of the multiple different CDNs of the Multi-CDN employs edge computing technology which enables a user of the Multi-CDN to execute custom code on platforms of the at least one respective CDN, the system comprising:
at least one hardware processor;
at least one computer readable storage device storing instructions for execution by the at least one hardware processor, the instructions, when executed, cause the system to enable the Multi-CDN to provide one or more unified services across the multiple different CDNs by utilizing the edge computing technology employed by the at least one CDN, wherein each unified service of the one or more unified services provides a consistent service across the multiple different CDNs.

2. The system according to claim 1, wherein the at least one CDN of the multiple different CDNs employing edge computing technology comprises the multiple different CDNs of the Multi-CDN, and the one or more unified services comprise one or more unified application services, and wherein the instructions, when executed, further cause the system to provide the one or more unified application services via the edge computing technology.

3. The system according to claim 1, wherein the one or more unified services comprise one or more unified CDN services, and wherein the instructions, when executed, further cause the system to unify one or more CDN services via the edge computing technology, to enable the one or more unified CDN services, respectively, and wherein each CDN service of the one or more CDN services is provided by at least one CDN of the Multi-CDN.

4. The system according to claim 1, further comprising a unified management system, wherein the unified management system allows the management of the multiple different CDNs in a unified and consistent manner and as a single CDN, and wherein the unified management system allows management of services executed on the multiple different CDNs, the services are selected from: CDN services, unified services, or a combination thereof.

5. The system according to claim 1, wherein the Multi-CDN may provide a user with a maximal level of service capabilities, the maximal level is the highest common level of service capabilities provided by the multiple different CDNs, and wherein enabling the Multi-CDN to provide one or more unified services comprises upgrading the maximal level of service capabilities of the Multi-CDN.

6. The system according to claim 5, wherein the upgrading of the maximal level of service capabilities of the Multi-CDN comprises causing the provision of one or more services, which the Multi-CDN was not capable of providing prior to the upgrading, and wherein the one or more services are unified services.

7. The system according to claim 6, wherein the one or more unified services comprise one or more unified application services, and wherein the at least one CDN of the plurality of CDNs employing edge computing technology comprises the multiple different CDNs of the Multi-CDN.

8. The system according to claim 7, wherein the types of services provided by the one or more unified application services are selected from: security, edge-computing, traffic control or content processing.

9. The system according to claim 8, wherein the unified security application services comprise at least one application service selected from: Web Application Firewall (WAF), bot detection, rate-limiting, Distributed Denial-of-Service (DDoS) protection, API security, client reputation, or anomaly detection.

10. The system according to claim 8, wherein the unified traffic control application services comprise at least one application service selected from: origin load balancing or origin routing.

11. The system according to claim 8, wherein the unified content processing application services comprise at least one application service selected from: image and video optimization or image and video manipulation.

12. The system according to claim 7, wherein the implementation of the one or more unified application services is performed via an edge compute layer deployed on top of the multiple different CDNs platforms based on the edge computing technology employed by the multiple different CDNs.

13. The system according to claim 12, wherein the edge compute layer is deployed via one or more worker agents, each worker agent of the one or more worker agents is installed on a platform of a CDN of the multiple different CDNs via the edge computing technology, respectively, wherein the one or more unified application services are executed on the multiple CDNs platforms via the one or more worker agents.

14. The system according to claim 7, wherein the one or more unified application services comprise a unified edge-computing application service providing a unified programming language and comprising at least one of: one or more Application Programming Interfaces (APIs), a runtime environment, a shared persistent state, or a combination thereof.

15. The system according to claim 6, wherein the one or more services comprise one or more CDN services, and wherein for each CDN service of the one or more CDN services:
a portion of the multiple different CDNs is not capable of providing the CDN service,
the rest of the multiple different CDNs are capable of providing the CDN service,
the at least plurality of CDNs employing edge computing technology comprise the portion of the CDNs not capable of providing the CDN service, and
the upgrading of the level of capabilities of the Multi-CDN comprises causing the portion of CDNs to provide the CDN service by utilizing the edge computing technology employed by the portion of CDNs, respectively.

16. The system according to claim 1, wherein:
each CDN of the multiple different CDNs of the Multi-CDN is capable of providing a CDN service at a certain level of service capability,
at least some of the CDNs of the multiple different CDNs are capable of providing the CDN service at different levels of service capability,
the Multi-CDN may provide the user with the CDN service at the lowest level of service capability of the different levels of service capability,
upgrading of the level of capabilities of the Multi-CDN comprises causing the Multi-CDN to provide the CDN service at an upgraded level of service capability higher than the lowest level of service capability and selected from the different levels, by causing the one or more CDNs which may provide the CDN service at a level of service capability lower than the upgraded level of service capability to provide the CDN service at the upgraded level of service capability, and
the one or more CDNs, capable of providing the CDN service at a level lower than the upgraded level of service capability, employ edge computing technology.

17. A computerized method for enabling a Multi-Content-Delivery-Network (Multi-CDN) to provide one or more unified services, the Multi-CDN comprising multiple different Content Delivery Networks (CDNs) provided by multiple different CDN providers, wherein at least one CDN of the multiple different CDNs of the Multi-CDN employs edge computing technology which enables the user of the Multi-CDN to execute custom code on platforms of the respective CDNs, the method comprising enabling the Multi-CDN to provide one or more unified services across the multiple different CDNs by utilizing the edge computing technology employed by the at least one CDN, wherein each unified service of the one or more unified services provides a consistent service across the multiple different CDNs.

18. The method according to claim 17, wherein the at least one CDN of the multiple different CDNs employing edge computing technology comprises the multiple different CDNs of the Multi-CDN, and wherein the one or more unified services comprise one or more unified application services, the method further comprising providing the one or more unified application services via the edge computing technology.

19. The method according to claim 17, wherein the one or more unified services comprise one or more unified CDN services, and wherein the method further comprises unifying one or more CDN services via the edge computing technology, to enable the one or more unified CDN services, respectively, and wherein each CDN service of the one or more CDN services is provided by at least one CDN of the Multi-CDN.

20. The method according to claim 17, further comprising allowing the management of the multiple different CDNs in a unified and consistent manner via a unified management system, and
wherein allowing management of the multiple different CDNs comprises allowing the management of the multiple different CDNs as a single CDN.

21. The method according to claim 17, wherein the Multi-CDN may provide a user with a maximal level of service capabilities, the maximal level is the highest common level of service capabilities provided by the multiple different CDNs, and wherein enabling the Multi-CDN to provide one or more unified services comprises upgrading the maximal level of service capabilities of the Multi-CDN.

22. The method according to claim 21, wherein the upgrading of the maximal level of service capabilities of the Multi-CDN comprises causing the provision of one or more services, which the Multi-CDN was not capable of providing prior to the upgrading, and wherein the one or more services are unified services.

23. The method according to claim 22, wherein the one or more services comprise one or more unified application services, and wherein the at least plurality of CDNs employing edge computing technology comprises the multiple different CDNs of the Multi-CDN.

24. The method according to claim 23, wherein the types of services provided by the one or more unified application services are selected from: security, edge-computing, traffic control or content processing.

25. The method according to claim 24, wherein the unified security application services comprise at least one application service selected from: Web Application Firewall (WAF), bot detection, rate-limiting, Distributed Denial-of-Service (DDoS) protection, API security, client reputation, or anomaly detection.

26. The method according to claim 24, wherein the unified traffic control application services comprise at least one application service selected from: origin load balancing or origin routing.

27. The method according to claim 24, wherein the unified content processing application services comprise at least one application service selected from: image and video optimization or image and video manipulation.

28. The method according to claim 23, further comprising deploying an edge compute layer on top of the multiple different CDNs platforms based on the edge computing technology employed by the multiple different CDNs, wherein causing the provision of the one or more unified application services is performed via the deployed edge compute layer.

29. The method according to claim 28, wherein the deploying of the edge compute layer comprises installing one or more worker agents on platforms of the multiple different CDNs via the edge computing technology, and wherein the one or more unified application services are executed on the multiple CDNs platforms via the one or more worker agents.

30. The method according to claim 23, wherein the one or more unified application services comprise a unified edge-computing application service, and wherein the unified edge-computing application service provides a unified programming language and comprises at least one of: one or more Application Programming Interfaces (APIs), a runtime environment, a shared persistent state, or a combination thereof.

31. The method according to claim 22, wherein the one or more services comprise one or more CDN services, and wherein for each CDN service of the one or more CDN services:
a portion of the multiple different CDNs is not capable of providing the CDN service,
the rest of the multiple different CDNs are capable of providing the CDN service,
the at least plurality of CDNs employing edge computing technology comprise the portion of the CDNs not capable of providing the CDN service, and
the upgrading of the level of capabilities of the Multi-CDN comprises causing the portion of CDNs to provide the CDN service by utilizing the edge computing technology employed by the portion of CDNs, respectively.

32. The method according to claim 17, wherein:
each CDN of the multiple different CDNs of the Multi-CDN is capable of providing a CDN service at a certain level of service capability,
at least some of the CDNs of the multiple different CDNs are capable of providing the CDN service at different levels of service capability,
the Multi-CDN may provide the user with the CDN service at the lowest level of service capability of the different levels of service capability,
upgrading of the level of capabilities of the Multi-CDN comprises causing the Multi-CDN to provide the CDN service at an upgraded level of service capability higher than the lowest level of service capability and selected from the different levels, by causing the one or more CDNs which may provide the CDN service at a level of service capability lower than the upgraded level of service capability to provide the CDN service at the upgraded level of service capability, and the one or more CDNs, capable of providing the CDN service at a level lower than the upgraded level of service capability, employ edge computing technology.

33. A system for providing unified application services on top of multiple different Content Delivery Networks (CDNs) provided by multiple different CDN providers, wherein each CDN of the multiple different CDNs employs edge computing technology which enables a user of the multiple different CDNs to execute custom code on the platform of the respective CDN, the system comprising:
at least one hardware processor;
at least one computer readable storage device storing instructions for execution by the at least one hardware processor, the instructions, when executed, cause the system to implement one or more unified application services to be executed on the platforms of the multiple different CDNs by employing the edge computing technology, wherein each service provided by each unified application service of the one or more unified application services is consistent across the multiple different CDNs.

34. A computerized method for providing unified application services on top of multiple different Content Delivery Networks (CDNs) provided by multiple different CDN providers, wherein each CDN of the multiple different CDNs employs edge computing technology which enables a user of the multiple different CDNs to execute custom code on the platform of the respective CDN, the method further comprising implementing one or more unified application services to be executed on the platforms of the multiple different CDNs by employing the edge computing technology, wherein each service provided by each unified application service of the one or more unified application services is consistent across the multiple different CDNs.

35. A computer program product for enabling a Multi-Content-Delivery-Network (Multi-CDN) to provide one or more unified services, the Multi-CDN comprising multiple different Content Delivery Networks (CDNs) provided by multiple different CDN providers, wherein at least one CDN of the multiple different CDNs of the Multi-CDN employs edge computing technology which enables a user of the Multi-CDN to execute custom code on platforms of the at least one respective CDN, the computer product comprising a computer-readable storage medium having computer-executable instructions for enabling the Multi-CDN to provide one or more unified services across the multiple different CDNs by utilizing the edge computing technology employed by the at least one CDN, wherein each unified service of the one or more unified services provides a consistent service across the multiple different CDNs.
